(19) United States
(12) Patent Application Publication
(10) Pub. No.: US 2026/0228008 A1
(43) Pub. Date: Aug. 6, 2026

(54) ON-CHIP DECOMPRESSION AND SPARSITY DECODE

(71) Applicant: Intel Corporation, Santa Clara, CA (US)

(72) Inventor: Ashwani KUMAR, Bangalore (IN)

(73) Assignee: Intel Corporation, Santa Clara, CA (US)

(21) Appl. No.: 19/632,234

(22) Filed: Mar. 28, 2026

(51) Int. Cl. G06F 9/30

(52) U.S. Cl. CPC G06F 9/30145

(57) ABSTRACT

Techniques for decompression and sparsity decoding are described. Examples detailed herein utilize a matrix data micro-engine invoked by an instruction and configured using a descriptor. The matrix data micro-engine pulls in data from memory (e.g., in a stream of blocks) and processes this data to make it ready for computational hardware. This effectively decouples the memory access patterns from the compute cadence. The use of the descriptor allows for complex, multi-stage data transformations (e.g., INT4 to FP16 conversion, 2:4 sparsity expansion, and layout transposition) to occur strictly within the hardware data path (stream decompressor and sparsity mask decoder) without polluting the instruction cache with decompression code or burdening the main CPU pipeline.

### BACKGROUND

Modern machine learning inference is frequently memory-bound and software-decode bound as large model weight matrices (e.g., transformer feed-forward networks (FFNs), embedding tables, etc.) do not fit into lower levels of cache (e.g., L1, L2, etc. cache), causing frequent memory traffic and high energy per inference. Weights are stored compressed (INT8/INT4) or scaled for efficiency, but software decoding/unpacking and layout transforms consume vector cycles, pollute caches, and waste energy. Structured sparsity and packed quant formats create irregular access patterns; software implementations suffer branch/loop overhead and prefetch inefficiency.

### BRIEF DESCRIPTION OF DRAWINGS

Various examples in accordance with the present disclosure will be described with reference to the drawings, in which:

FIG. 1 illustrates examples of a block diagram of a computing system capable of performing descriptor-driven on-chip decompression and sparsity decoding for matrix operations.

FIG. 2 examples of a structure of a descriptor 103 used to control the matrix data micro-engine.

FIG. 3 illustrates example instruction formats for a single instruction that triggers a matrix data micro-engine.

FIG. 4 illustrates an example method performed by a processor to process an instruction.

FIG. 5 illustrates examples of computing hardware to process an instruction.

FIG. 6 illustrates an example computing system.

FIG. 7 illustrates a block diagram of an example processor and/or System on a Chip (SoC) that may have one or more cores and an integrated memory controller.

FIG. 8 is a block diagram illustrating a computing system configured to implement one or more aspects of the examples described herein.

FIG. 9 shows a parallel compute system, according to some examples.

FIGS. 10A-10B illustrate a hybrid logical/physical view of a disaggregated parallel processor, according to examples described herein.

FIG. 11(A) is a block diagram illustrating both an example in-order pipeline and an example register renaming, out-of-order issue/execution pipeline according to examples.

FIG. 11(B) is a block diagram illustrating both an example in-order architecture core and an example register renaming, out-of-order issue/execution architecture core to be included in a processor according to examples.

FIG. 12 illustrates examples of execution unit(s) circuitry, such as execution unit(s) circuitry.

FIG. 13 is a block diagram of a register architecture according to some examples.

FIG. 14 illustrates examples of an instruction format.

FIG. 15 illustrates examples of an addressing information field.

FIGS. 16(A)-(B) illustrate examples of a first prefix.

FIGS. 17(A)-(D) illustrate examples of how the R, X, and B fields of the first prefix are used.

FIGS. 18(A)-(B) illustrate examples of a second prefix.

FIGS. 19(A)-(E) illustrate examples of a third prefix.

FIG. 20 is a block diagram illustrating the use of a software instruction converter to convert binary instructions in a source ISA to binary instructions in a target ISA according to examples.

FIG. 21 is a block diagram illustrating an IP core development system 2100 that may be used to manufacture an integrated circuit to perform operations according to some examples.

### DETAILED DESCRIPTION

The present disclosure relates to methods, apparatus, systems, and non-transitory computer-readable storage media for decompression and sparsity decode using an instruction.

Existing solutions to that detailed above include software only solutions. For example, some software kernels (e.g., oneDNN, OpenVINO) pack/unpack, dequantize, and apply layout transforms using vector loops on a central processing unit (CPU). However, this consumes significant cycles and cache bandwidth. In some previous solutions, matrix tiles provide for fast matrix operations (e.g., GEMM operations), but these tiles require explicit tile loads/stores and software-based unpack/dequantization/layout. These tiles may reduce computation cycles but do not remove weight decompression or structured sparsity bookkeeping from software.

Examples detailed herein address the “memory wall” problem prevalent in modern high-performance computing, specifically in the context of deep learning inference where the movement of model weights from memory to compute units creates a significant bottleneck. As noted above, in prior art systems, a processor must fetch high-precision data (e.g., FP16 or FP32) directly from memory, consuming substantial bandwidth, or fetch compressed data and use valuable general-purpose vector cycles to decompress and permute the data before it can be used. This conventional approach results in high latency, excessive power consumption due to data movement, and underutilization of the matrix arithmetic units which must stall while waiting for data preparation.

Examples detailed herein utilize a matrix data micro-engine invoked by an instruction and configured using a descriptor. The matrix data micro-engine pulls in data from memory (e.g., in a stream of blocks) and processes this data to make it ready for computational hardware. This effectively decouples the memory access patterns from the compute cadence. The use of the descriptor allows for complex, multi-stage data transformations (e.g., INT4 to FP16 conversion, 2:4 sparsity expansion, and layout transposition) to occur strictly within the hardware data path (stream decompressor and sparsity mask decoder) without polluting the instruction cache with decompression code or burdening the main CPU pipeline. This results in a reduction of memory bandwidth consumption by a factor proportional to the compression ratio (e.g., 4× bandwidth savings for INT4 vs. FP16), directly translating to higher effective throughput for bandwidth-bound workloads like Large Language Model (LLM) inference. Furthermore, the inclusion of the prefetch scheduler driven by the descriptor's prefetch length ensures that the matrix hardware is consistently fed with valid data, thereby maximizing the utilization of the silicon area dedicated to matrix math.

Examples detailed herein reduce memory traffic and decode cycles, simplify software through the use of a single instruction to cause retrieval and manipulation of data in memory, etc.

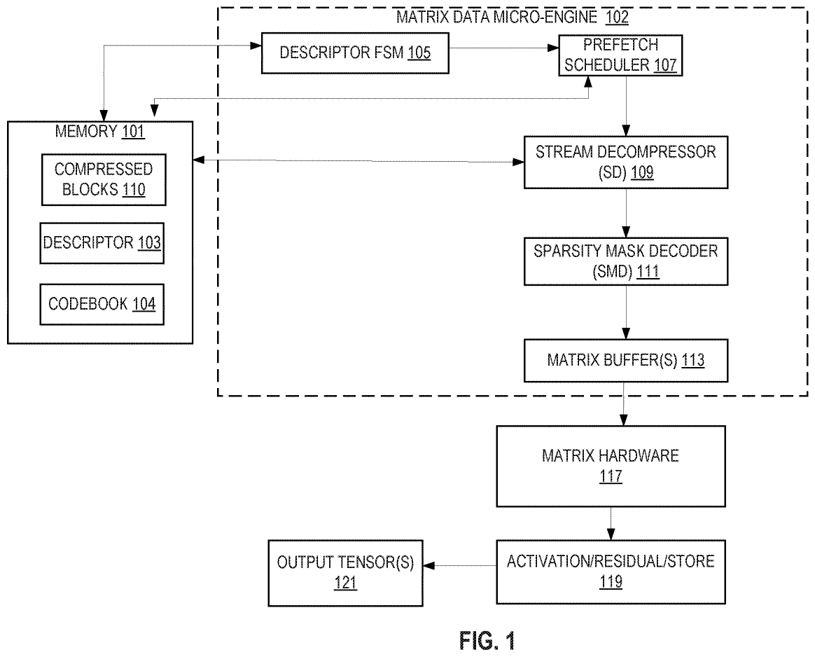

FIG. 1 illustrates examples of a block diagram of a computing system capable of performing descriptor-driven on-chip decompression and sparsity decoding for matrix operations. Aspects computing system may be implemented as a standalone system-on-chip (SoC), a central processing unit (CPU) with integrated matrix extensions, a graphics processing unit (GPU) featuring matrix and/or tensor acceleration cores, or a specialized neural processing unit (NPU). The architecture decouples the high-bandwidth requirements of fetching matrix data from the computational throughput of matrix arithmetic units. By embedding a specialized execution path for data ingestion, the system mitigates the “memory wall” associated with modern machine learning workloads, particularly large language model (LLM) inference and sparse embedding lookups. The system comprises a general-purpose processor pipeline (not fully shown) that is coupled to a specialized matrix data micro-engine 102. This coupling allows the main processor to offload the complex tasks of memory fetching, decompression, and sparsity handling to the matrix data micro-engine 102 via a single instruction, thereby freeing up general-purpose execution units for control flow, scalar, and/or vector operations.

The system includes a memory 101 to store data consumed by the execution circuitry (e.g., compressed blocks 110) and/or a descriptor 103 to be used by a matrix data micro-engine 102. The memory 101 is implemented as dynamic random-access memory (DRAM), high-bandwidth memory (HBM) stacked directly on the interposer with the compute die, a hierarchical cache structure (e.g., Level 2, Level 3, or Level 4 cache) that is shared across multiple cores or tiles, disk, etc.

The memory 101 stores compressed blocks 110 representing matrix data. These compressed blocks 110 may include weights for machine learning models, such as the feed-forward networks of transformer models or embedding tables used in recommendation systems. The data within the compressed blocks 110 is stored in a packed format—for example, packing multiple 4-bit integers (INT4) into a single contiguous memory word—to minimize the memory bandwidth required to transfer the data from the memory 101.

Additionally, the memory 101 stores at least one descriptor 103. The descriptor 103 is a data structure that defines the parameters for a specific operation of the matrix data micro-engine 102. Rather than encoding all transfer parameters into the instruction opcode itself, the system utilizes the descriptor 103 to store metadata such as one or more of a source address for the compressed blocks 110 (the address may be a virtual address or a physical address depending on the implementation), a data type for the compressed blocks, a sparsity format, and/or transformation rules. The descriptor 103 acts as a contract between the software (e.g., the compiler or driver) and the hardware, specifying exactly how the bits in the compressed blocks 110 should be interpreted and reconstructed into consumable values (e.g., weights).

The matrix data micro-engine 102 is specialized execution hardware that includes a finite state machine 105 that is architecturally distinct from the standard load/store units of a CPU or GPU. The matrix data micro-engine 102 executes a “TENSORSTREAM” class of instructions by autonomously managing the lifecycle of data movement from the memory 101 to be available to execution units. The matrix data micro-engine 102 is comprised of several interacting sub-components that form a decompression and decoding pipeline.

A descriptor finite state machine (FSM) 105 serves as the controller for the micro-engine 102. Upon the issuance of a relevant TENSORSTREAM instruction, the descriptor FSM 105 is responsible for fetching the descriptor 103 from the memory 101 using the address provided in the instruction operands. The descriptor FSM 105 parses the fields of the descriptor 103 to configure the downstream logic. It maintains the state of the current transfer operation, tracking progress, handling error conditions, and signaling completion to the main processor pipeline.

Coupled to the FSM 105 is a prefetch scheduler 107. The prefetch scheduler 107 issues memory read requests for the compressed blocks 110, starting at a base address from the descriptor 103 and according to a block size and prefetch length, ahead of the demand from the decompression logic. By utilizing a “prefetch length” parameter from the descriptor 103, the prefetch scheduler 107 attempts to keep the pipeline filled to effectively hide the latency associated with accessing the memory 101. The prefetch scheduler 107 may monitor the buffer occupancy of downstream components and throttles memory requests to prevent overflow while maximizing bus utilization.

The data fetched by the scheduler is passed to the stream decompressor (SD) 109. The stream decompressor 109 contains hardware logic optimized for decoding the specific packed formats stored in the compressed blocks 110. For example, the stream decompressor 109 may include circuit paths for extracting and up-converting data types such as two-bit integers (INT2), four-bit integers (INT4), eight-bit integers (INT8), 16-bit integer (INT16) or various floating-point formats (FP4, FP8 (e.g., 1-4-3, 1, 2-5, 1-3-4, etc.), FP16 (e.g., IEEE half precision, BF16, etc.)) into a format required by the underlying execution (e.g., the format of weights of a LLM, etc.). In some examples, this is a dequantization.

In examples, utilizing Product Quantization (PQ) or Vector Quantization (VQ), the stream decompressor 109 performs indirect lookups. It uses indices extracted from the compressed stream to retrieve values from a codebook 104 (referenced via a codebook pointer in the descriptor 103), effectively reconstructing the original high-precision values from low-precision indices. The stream decompressor 109 may also apply scaling factors (scales) and/or zero-point offsets to the dequantized data to restore the dynamic range of the tensor. Furthermore, if the descriptor indicates a transformation (e.g., transposition, padding, etc.), the stream decompressor 109 rearranges the elements within the local buffers to match the required layout (e.g., converting batch (N), channel (C), height (H), and width (W) (e.g., NCHW) to NHWC).

Following decompression, the decompressed data flows to the sparsity mask decoder (SMD) 111. The sparsity mask decoder 111 is hardware to interpret sparsity metadata associated with the matrix data. This metadata, which may be defined by a “sparse mask format” field in the descriptor dictates which elements of the matrix are non-zero. The sparsity mask decoder 111 supports formats such as N: M structured sparsity (e.g., 2:4 sparsity, where two out of every four elements are non-zero) or block compressed sparse row (CSR) formats. Based on this metadata, the sparsity mask decoder 111 generates and emits a stream of tokens. In a “dense expansion” mode, the sparsity mask decoder 111 inserts zero values into the stream at the positions indicated by the mask, thereby reconstructing a full, dense matrix tile from compressed sparse data. In a “sparse native” mode, the sparsity mask decoder 111 emits index/value pairs (tokens) that explicitly identify the coordinates and values of non-zero elements, suitable for consumption by sparse-aware hardware.

The output of the sparsity mask decoder 111 is buffered into one or more matrix buffer(s) 113. The matrix buffer(s) 113 decouple the memory domain from the compute domain (which consumes data at a deterministic rate). The matrix buffer(s) 113 may be implemented as circular buffers, scratchpad memories, a set of architectural matrix (e.g., tile) and/or vector registers. This buffering ensures that the arithmetic units are not stalled waiting for memory fetches.

The processed data is consumed by the matrix hardware 117. The matrix hardware 117 represents the computational engine of the apparatus, which may be realized as a systolic array, a tensor core complex within a GPU, an NPU, or a CPU matrix coprocessor (e.g., Advanced Matrix Extensions (AMX)). The matrix hardware 117 reads the fully decompressed, dequantized, and expanded matrix tiles or sparse tokens directly from the addressable matrix buffer(s) 113. Because the data in the buffer(s) is already in the format required by the hardware, the matrix hardware 117 can proceed immediately with dot products, convolutions, or matrix multiplications without spending cycles on data preparation.

Finally, the results of the matrix operations may be processed by the activation/residual/store unit 119. This unit 119 includes logic for applying non-linear activation functions (e.g., ReLU, GELU, Sigmoid, etc.) to the output of a matrix operation (e.g., multiplication, addition, etc.). The unit 119 may also handle residual additions (adding the output to a tensor from a previous layer) and bias application. Once the post-processing is complete, the activation/residual/store unit 119 writes the resulting tensor 121 back to the memory 101 or to a different location in the cache hierarchy, ready for the next layer of computation.

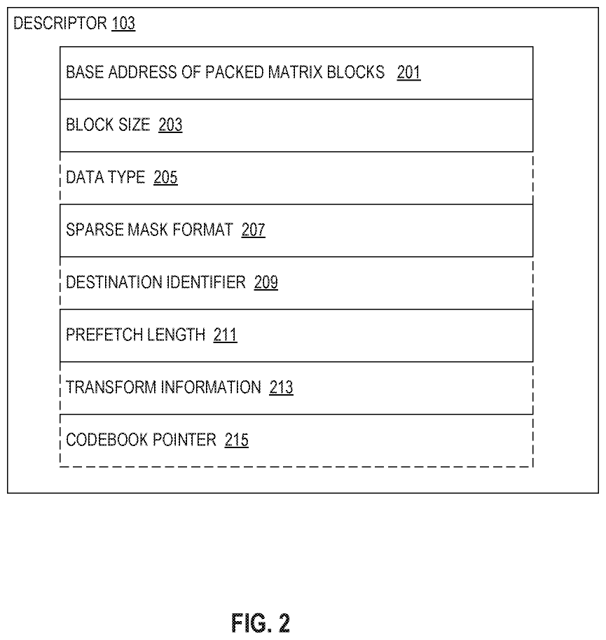

FIG. 2 examples of a structure of a descriptor 103 used to control the matrix data micro-engine. The descriptor 103 is a data structure stored in memory 101 that defines the set of parameters required for the streaming, decompression, and decoding operations. In some examples, the descriptor 103 is aligned to a specific boundary, such as a 64-byte cache line boundary, to ensure that the descriptor finite state machine (FSM) 105 can retrieve the entire control block in a single memory access cycle, thereby minimizing the initialization latency of the transfer operation. The descriptor 103 effectively functions as a hardware-software contract, allowing the software stack (e.g., a compiler or device driver) to offload complex data ingestion tasks to the hardware by populating the fields of the descriptor 103 rather than executing a long sequence of scalar instructions.

The descriptor 103 includes a base address for packed matrix blocks 201. This field specifies the starting physical address or virtual address in the memory 101 where the payload of compressed blocks 110 is located. In embodiments utilizing virtual addressing, the descriptor FSM 105 or the prefetch scheduler 107 interacts with a memory management unit (MMU) or translation lookaside buffer (TLB) to translate the base address of packed matrix blocks 201 into a physical address suitable for memory controller requests. The base address serves as the anchor point from which the prefetch scheduler 107 calculates subsequent read addresses as it traverses the stream of compressed data.

A block size field 203 is included to indicate the granularity or size of each individual packed matrix block within the stream. This size may be defined in bytes, cache lines, or memory pages (e.g., 4 KB). The block size 203 is critical for the prefetch scheduler 107 to manage the boundaries of memory requests and to ensure that the stream decompressor 109 receives complete, valid data chunks. For example, if the compressed blocks 110 are stored as 4 KB pages, the block size 203 instructs the hardware to issue requests that align with page boundaries, thereby optimizing the row buffer hit rate in the DRAM system.

The descriptor 103 includes a data type field 205 in some examples. This field encodes the format of the source data stored in the compressed blocks 110 and, in some embodiments, the target format required by the matrix hardware 117. The data type field 205 may specify a wide range of low-precision or compressed formats, including but not limited to two-bit integers (INT2), four-bit integers (INT4), eight-bit integers (INT8), four-bit floating point (FP4), eight-bit floating point (FP8), sixteen-bit floating point, or block floating point formats. The stream decompressor 109 is configured using the data type field 205 and used to unpack the incoming bits (e.g., extracting two 4-bit nibbles from a byte) and how to cast or convert them into the higher-precision format (e.g., 16-bit BF16 or FP16) used by the matrix hardware 117.

A sparse mask format field 207 may be provided to define the metadata encoding used to represent sparsity within the matrix data. This field instructs the sparsity mask decoder 111 on how to interpret the incoming data stream to reconstruct the spatial structure of the tensor. For example, the sparse mask format field 207 may indicate a 2:4 structured sparsity format, where a 2-bit mask accompanies every block of four elements to identify which two elements are non-zero. Alternatively, the sparse mask format field 207 may indicate a compressed sparse row (CSR) format or a block-sparsity bitmap. By reading this field, the sparsity mask decoder 111 is dynamically reconfigured to parse the metadata headers or interleaved mask bits correctly, enabling the hardware to support multiple sparsity standards without requiring different silicon structures for each.

The descriptor 103 may include a destination identifier 209. This field explicitly identifies the target storage location within the matrix buffer(s) 113. The destination identifier 209 acts as a routing tag that directs the output of the sparsity mask decoder 111 to a specific buffer within the matrix buffer(s) 113. By embedding the destination information in the descriptor 103, the apparatus allows for flexible double-buffering or circular-buffering schemes where the producer (the matrix data micro-engine 102) fills one buffer while the consumer (the matrix hardware 117) operates on another.

The descriptor 103 may include a prefetch length field 211. This field provides a hint or a strict definition of the quantity of data (e.g., number of blocks or cache lines) that the prefetch scheduler 107 should attempt to fetch ahead of the current consumption point. A larger prefetch length 211 allows the apparatus to tolerate higher memory latencies by keeping the pipeline deep, which is particularly advantageous when accessing off-chip high-bandwidth memory (HBM). The prefetch scheduler 107 uses this value to throttle its request generation, ensuring that the internal buffers do not overflow while preventing starvation of the stream decompressor 109.

Transform information 213 may be included to specify geometric transformations or layout permutations to be applied to the matrix data during the decompression process. This field may encode operations such as matrix transposition (swapping rows and columns), rotation, or layout conversion (e.g., changing from NCHW channel-first format to NHWC channel-last format). The stream decompressor 109 utilizes the transform information 213 to adjust the write-addressing logic of its internal scratchpads, effectively “shuffling” the data elements into the desired arrangement before they are written to the matrix buffer(s) 113. This capability eliminates the need for separate, costly “shuffle” or “permute” instructions in the main instruction stream.

Finally, a codebook pointer 215 is provided for embodiments utilizing Product Quantization (PQ) or Vector Quantization (VQ). The codebook pointer 215 contains the physical or virtual address of a codebook 104 (e.g., lookup table) stored in memory 101. When the data type 205 indicates a quantized format requiring a lookup, the matrix data micro-engine 102 uses the codebook pointer 215 to pre-load the codebook into a local look-up table (LUT) memory within the stream decompressor 109. This allows the stream decompressor 109 to decode the compressed stream by using the data values as indices into the locally stored codebook, retrieving the full-precision centroids or values without incurring an access penalty for every element.

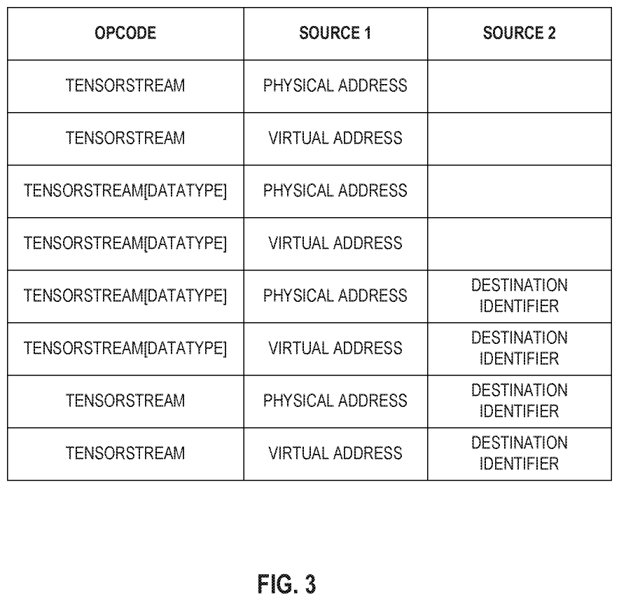

FIG. 3 illustrates example instruction formats for a single instruction (e.g., TENSORSTREAM) that triggers the matrix data micro-engine. The instruction serves as the architectural trigger that activates the autonomous hardware pipeline described in FIG. 1. The instruction includes an opcode field (e.g., “TENSORSTREAM”) that is recognized by the decoder circuitry of the processor core. Upon decoding this opcode, the processor does not execute the operation in the standard arithmetic logic units (ALUs) but instead routes the decoded micro-operation to the descriptor FSM 105 of the matrix data micro-engine 102.

The instruction format includes at least one field to identify a location in memory that is to store the descriptor 103. As shown in the “Source 1” column of FIG. 3, this operand may specify a physical address or a virtual address of the descriptor. In a virtual addressing mode, the execution circuitry performs a virtual-to-physical translation (e.g., via a TLB lookup) before passing the physical address to the descriptor FSM 105. The Source 1 operand may be encoded as a register specifier (e.g., a general-purpose register holding the 64-bit pointer) or as a direct memory operand with displacement. This flexibility allows the software to dynamically generate descriptors on the stack or heap and pass their pointers to the hardware.

In some embodiments, the instruction includes a Source 2 operand. As illustrated in FIG. 3, Source 2 may specify a destination identifier. When present, this operand overrides or supplements the destination identifier 209 found within the descriptor 103 itself. This override mechanism is particularly useful in loop optimizations (e.g., loop unrolling), where the parameters of the transfer (source address, data type) remain constant (defined in a static descriptor), but the target register (e.g., Tile 0 vs. Tile 1) changes with each iteration to facilitate pipelined execution. If Source 2 is not present, the matrix data micro-engine 102 defaults to the destination specified in the descriptor 103.

Variations of the instruction may also include indicate a datatype (e.g., INT4, INT8, etc.) using an immediate value or be encoded as a part of the opcode.

An example of a format for an TENSORSTREAM instruction is OPCODE DST, SRC. In some examples, OPCODE is the opcode mnemonic of the instruction. DST is a field for a location of destination operand (e.g., matrix buffer(s) 113). SRC is one or more fields to indicate a memory location of the descriptor. In some examples, the opcode is provided by field 1403, BPG12, or ‘BPU04. In some examples, source and/or destination locations are provided by one or more of bits from a prefix 1401 (e.g., R-bit, VVVV, etc.), addressing information 1405 (e.g., reg 1544, R/M 1546, SIB byte 1504, etc.), 1018, 1020, 1022, 1024, 1026, etc.

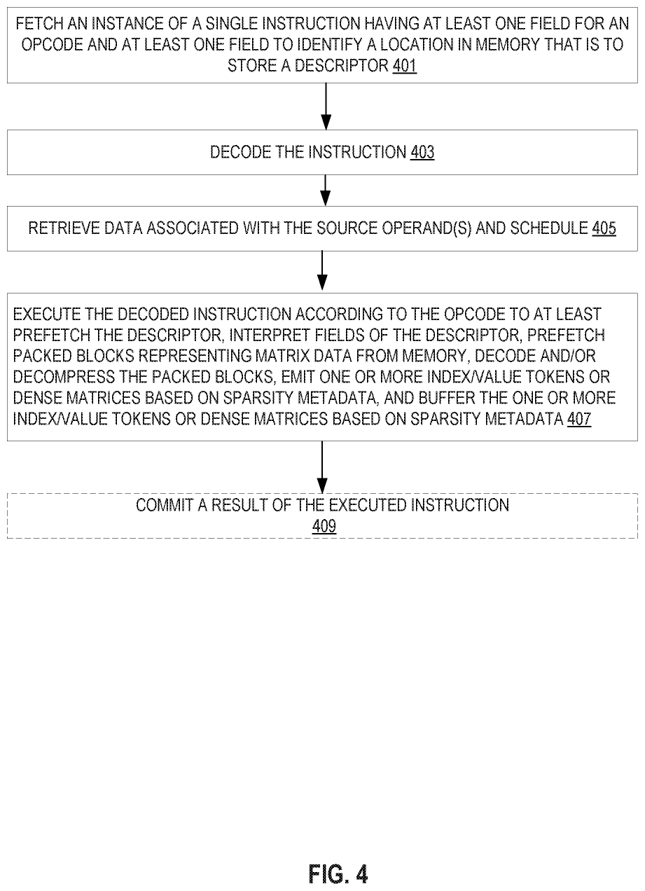

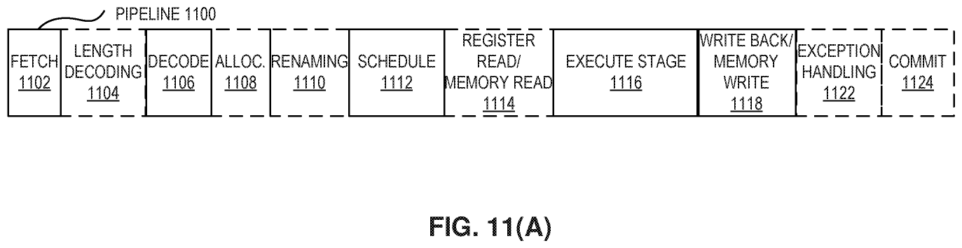

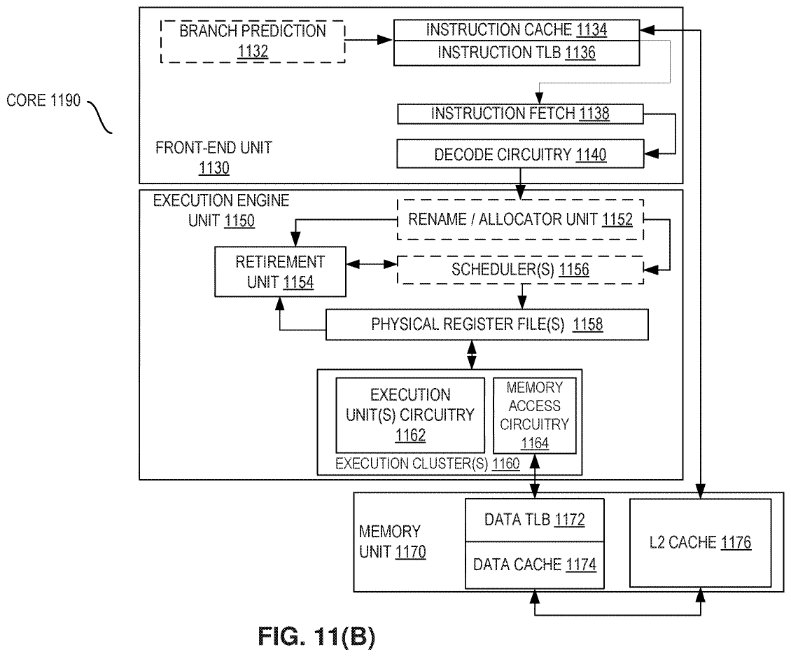

FIG. 4 illustrates an example method performed by a processor to process a TENSORSTREAM instruction. For example, a processor core as shown in FIG. 11(B), a pipeline as detailed below, etc., performs this method.

At 401, an instance of single instruction is fetched. For example, an instance of a TENSORSTREAM instruction is fetched. In some examples, the instance of the single instruction has at least one field for an opcode and at least one field to identify a location in memory that is to store a descriptor.

The fetched instruction is decoded at 403. For example, the fetched TENSORSTREAM instruction is decoded by decoder circuitry such as decoder circuitry 505 or decode circuitry 1140 detailed herein.

Data values associated with the source operands of the decoded instruction are retrieved when the decoded instruction is scheduled at 405. For example, when one or more of the source operands are memory operands, the data from the indicated memory location is retrieved. For example, a descriptor is retrieved from memory.

At 407, the decoded instruction is executed by execution circuitry (hardware) such as the matrix data micro-engine 102. The decoded instruction is executed according to the opcode to prefetch the descriptor, interpret fields of the descriptor, prefetch packed blocks representing matrix data from memory, decode and/or decompress the packed blocks, generates and emits one or more index/value tokens or dense matrices based on sparsity metadata, and buffer the one or more index/value tokens or dense matrices based on sparsity metadata. In some examples, transformation and/or codebook lookups are performed.

In some examples, the instruction is committed or retired at 409.

Some examples utilize instruction formats described herein. Some examples are implemented in one or more computer architectures, cores, accelerators, etc. Some examples are generated or are IP cores. Some examples utilize emulation and/or translation.

In some hardware implementation variants, the system described herein may be integrated into different types of processing units to optimize specific workloads. In one embodiment, the matrix hardware 117 is implemented as a Neural Processing Unit (NPU) integrated within a System-on-Chip (SoC). In this configuration, the matrix data micro-engine 102 functions effectively as an intelligent Direct Memory Access (DMA) frontend for a NPU, GPU, etc. The memory 101 may represent a system-level cache or global DRAM shared between a central processing unit (CPU) and the NPU. The matrix data micro-engine 102 resides at the interface between this shared memory and the NPU's internal scratchpad or local static random-access memory (SRAM). By offloading the decompression and sparsity expansion tasks, the matrix data micro-engine 102 ensures that the NPU's compute array receives a continuous stream of ready-to-compute data without requiring the NPU's control logic to handle complex addressing or bit-manipulation tasks. Alternatively, the matrix hardware 117 is a Graphics Processing Unit (GPU), and the matrix data micro-engine 102 is embedded within the GPU's streaming multiprocessors or texture mapping units. In this embodiment, the apparatus serves to feed Tensor Cores or matrix acceleration units within the GPU. The compressed blocks 110 are fetched from graphics memory (e.g., GDDR6 or HBM), and the stream decompressor 109 expands them directly into the vector register files or shared memory of the GPU, bypassing standard texture decompression pipelines that may be ill-suited for non-image tensor data.

Regarding data type and format variations, the stream decompressor 109 is configurable to support a wide array of numerical precisions and encoding schemes to balance dynamic range against memory footprint. In addition to standard integer formats such as two-bit integers (INT2), four-bit integers (INT4), eight-bit integers (INT8), and sixteen-bit integers (INT16), the architecture supports floating-point formats tailored for deep learning. These include four-bit floating point (FP4) (e.g., E2M1 or E3M0 variants), eight-bit floating point (FP8) (e.g., E4M3 or E5M2), sixteen-bit floating point (FP16), and Brain Floating Point (BF16). Furthermore, the descriptor 103 may indicate the use of custom block floating-point formats. In a block floating-point embodiment, a single shared exponent is stored for a block of values (e.g., a vector of 16 or 32 numbers), while individual values are stored as low-precision mantissas (e.g., 4-bit or 6-bit). The stream decompressor 109 is configured to read the shared exponent and apply it to each mantissa in the block during the expansion process, effectively reconstructing the full dynamic range of the numbers before they are written to the matrix buffer(s) 113. This approach significantly reduces the bit-width required per element compared to standard IEEE floating-point formats where each number carries its own exponent.

The sparsity handling mechanisms within the sparsity mask decoder 111 may operate in distinct modes depending on the capabilities of the downstream matrix hardware 117. In a dense expansion mode, which supports legacy matrix units that operate only on dense matrices, the sparsity mask decoder 111 utilizes the sparse mask format 207 to identify the positions of zero elements. The decoder then inserts zero values into the data stream at the appropriate locations to reconstruct a geometrically dense matrix tile from the compressed sparse representation. This allows software to store models in a sparse format to save memory capacity and bandwidth while executing on hardware that lacks native sparse support. Conversely, in a native sparse mode, the matrix hardware 117 is explicitly sparse-aware. In this mode, the sparsity mask decoder 111 emits the non-zero values along with coordinate metadata, such as Coordinate List (COO) indices or Compressed Sparse Row (CSR) pointers. The matrix buffer(s) 113 are then populated with packed non-zero values and their corresponding indices, allowing the matrix hardware 117 to skip computations involving zero operands entirely, thereby saving power and execution cycles.

In examples utilizing aggressive compression strategies, the decompression algorithms implemented by the stream decompressor 109 extend beyond simple quantization and packing. The stream decompressor 109 may include logic for Lempel-Ziv (LZ) style lossless decompression, which is applied to the compressed blocks 110 prior to dequantization. This allows for the exploitation of repeated bit patterns within the weight matrices to achieve higher compression ratios. Additionally, or alternatively, the stream decompressor 109 may support Huffman coding or arithmetic entropy coding. In such an embodiment, the descriptor 103 includes pointers to Huffman tables or probability models. The stream decompressor 109 decodes the variable-length symbols from the memory 101 into fixed-width quantization indices before proceeding with the dequantization and sparsity decoding steps. These advanced compression layers are particularly beneficial for bandwidth-constrained environments, such as edge AI processing, where minimizing the data transfer volume is critical for performance and energy efficiency. The matrix data micro-engine 102 thereby acts as a multi-stage decompression pipeline, abstracting the complexity of these algorithms from the main processor core.

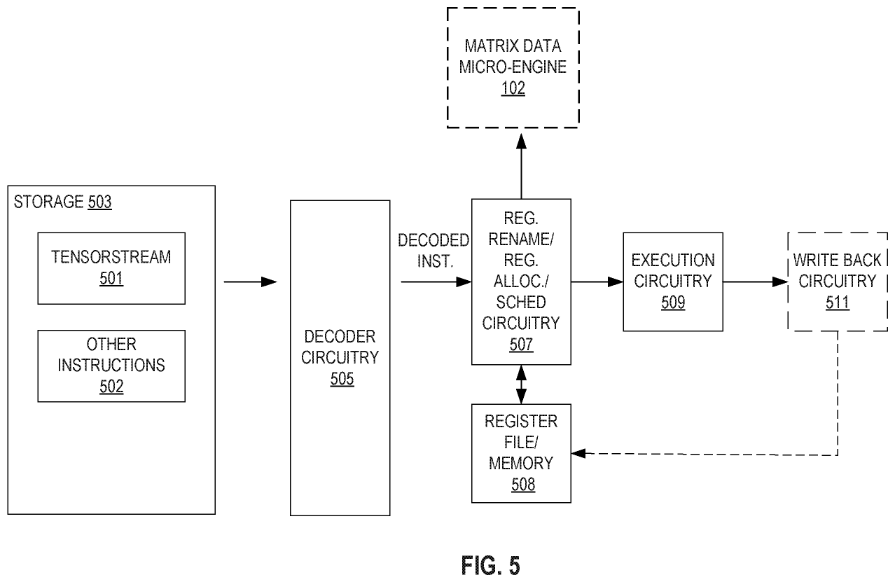

FIG. 5 illustrates examples of computing hardware to process a TENSORSTREAM instruction. The instruction may be a TENSORSTREAM instruction. As illustrated, storage 503 stores a TENSORSTREAM instruction 501 to be executed and/or other instructions 502.

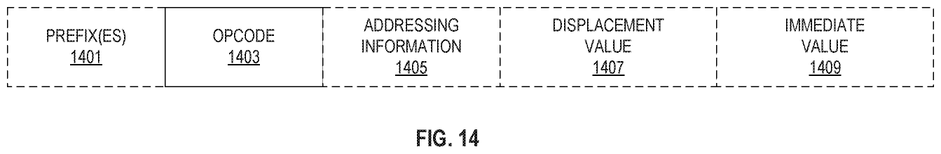

The TENSORSTREAM instruction 501 is received by decoder circuitry 505. For example, the decoder circuitry 505 receives this instruction from fetch circuitry (not shown). The instruction may be in any suitable format, such as that described with reference to FIG. 14 below.

More detailed examples of at least one instruction format for the instruction will be detailed later. The decoder circuitry 505 decodes the instruction into one or more operations. In some examples, this decoding includes generating a plurality of micro-operations to be performed by execution circuitry (such as execution circuitry 509). The decoder circuitry 505 also decodes instruction prefixes.

In some examples, register renaming, register allocation, and/or scheduling circuitry 507 provides functionality for one or more of: 1) renaming logical operand values to physical operand values (e.g., a register alias table in some examples), 2) allocating status bits and flags to the decoded instruction, and 3) scheduling the decoded instruction for execution by execution circuitry out of an instruction pool (e.g., using a reservation station in some examples). The matrix data micro-engine 102 executes the TENSORSTREAM instruction.

Registers (register file) and/or memory 508 store data as operands of the instruction to be operated by execution circuitry 509. Example register types include packed data registers, general purpose registers (GPRs), and floating-point registers.

Execution circuitry 509 executes non-TENSORSTREAM decoded instructions. Example detailed execution circuitry includes execution cluster(s) 1160 shown in FIG. 11(B), etc.

In some examples, retirement/write back circuitry 511 architecturally commits the destination register into the registers or memory 508 and retires the instruction.

Embodiments of the present disclosure provide significant improvements in memory bandwidth efficiency, particularly for bandwidth-constrained workloads such as Large Language Model (LLM) inference and high-throughput recommendation systems. A critical technical problem in conventional computing architectures, often referred to as the “memory wall,” is that the rate of data consumption by modern matrix execution units far exceeds the rate at which data can be fetched from off-chip memory. By utilizing the matrix data micro-engine 102 to fetch compressed blocks 110 directly from memory 101 and perform on-chip decompression via the stream decompressor 109, the apparatus effectively multiplies the available physical memory bandwidth. For instance, fetching weights encoded in a four-bit integer (INT4) format rather than a standard sixteen-bit floating point (FP16) format reduces the required data transfer volume by a factor of four. This reduction allows the memory subsystem to deliver tensor data at a rate that keeps the matrix hardware 117 fully utilized, mitigating fetch-induced stalls that otherwise degrade performance in batch-1 inference scenarios where weight loading is the primary bottleneck. Furthermore, by handling decompression and sparsity expansion locally within the execution circuitry, the system reduces the congestion on the global interconnect fabric, reserving system-level bandwidth for other critical operations such as activation spilling or inter-chip communication.

In addition to bandwidth optimization, the described system may reduce the software overhead associated with data preparation, which is a prevalent inefficiency in prior art single-instruction multiple-data (SIMD) architectures. Conventionally, preparing low-precision or sparse data for matrix multiplication requires a complex sequence of scalar and vector instructions to load, shuffle, unpack, and permute data into a format compatible with the compute units. These auxiliary instructions pollute the instruction cache, consume fetch and decode bandwidth, and occupy general-purpose vector execution ports that could otherwise be used for arithmetic operations. The present invention addresses this by offloading the entire fetch-decode-transform loop to the descriptor-driven matrix data micro-engine 102. A single instruction (e.g., TENSORSTREAM) triggers the descriptor FSM 105 to manage the data flow autonomously. This architectural decoupling frees up the main processor's reorder buffer (ROB) and issue logic, allowing the general-purpose cores to enter a low-power state or execute independent instruction streams while the stream decompressor 109 and sparsity mask decoder 111 transparently prepare the data in the background. Consequently, the computational throughput is no longer limited by the core's ability to issue data-shuffling micro-operations.

The apparatus further optimizes system latency and power consumption through intelligent hardware-managed prefetching and localized data processing. The prefetch scheduler 107 utilizes the prefetch length 211 specified in the descriptor 103 to issue memory read requests well in advance of the demand from the matrix hardware 117, effectively hiding the non-deterministic latency inherent in accessing DRAM or HBM. By maintaining a steady stream of compressed blocks 110 into the stream decompressor 109, the system ensures that the matrix buffer(s) 113 remain populated, preventing pipeline bubbles in the downstream compute logic. From a power perspective, transmitting data in a compressed format across the long physical wires of the chip—from the memory controller to the matrix data micro-engine 102—significantly reduces the dynamic power dissipated in the on-chip interconnect. The energy-intensive operation of expanding the data to its full width (e.g., 16-bit or 32-bit) occurs only at the final stage within the stream decompressor 109, immediately prior to consumption. This “compress-transmit-expand” strategy minimizes the energy-per-bit cost of data movement, which is increasingly dominant over compute energy in modern semiconductor processes.

The descriptor-based architecture may provide architectural scalability and forward compatibility compared to architectures that encode data formats directly into the instruction set architecture (ISA). In traditional designs, introducing a new data type, such as a novel four-bit floating point (FP4) variant, often requires adding new opcodes, updating the decoder logic, and potentially recompiling software binaries. In contrast, the present invention abstracts the data format details within the data type 205 field of the descriptor 103. This allows the hardware implementation of the stream decompressor 109 to be updated to support emerging quantization standards or proprietary block-floating point formats without altering the processor's ISA or the TENSORSTREAM opcode. Software can simply update the descriptor 103 in memory to leverage new hardware capabilities. This flexibility is particularly advantageous for adapting to the rapidly evolving landscape of machine learning quantization techniques, ensuring that the matrix hardware 117 can support future algorithmic innovations with minimal changes to the system software stack.

Examples of use cases (scenarios) are detailed below. In a first exemplary scenario involving Large Language Model (LLM) inference, the computing apparatus is utilized to overcome memory bandwidth limitations associated with the decoding phase of generative transformer models. During the generation of output tokens, particularly when operating with a batch size of one (batch-1 inference), the execution of Feed-Forward Networks (FFN) is predominantly memory-bound rather than compute-bound. In this context, the weights of the FFN layers, which may constitute hundreds of gigabytes of data, must be streamed from the memory 101 to the matrix hardware 117 for every single token generated. To address this, the compressed blocks 110 are stored in the memory 101 using a highly compressed format, such as 4-bit integers (INT4) or grouped 4-bit floating point (FP4), effectively reducing the required memory bandwidth by a factor of four compared to standard 16-bit formats. A descriptor 103 is constructed by the system software to point to these compressed weights, with the data type 205 field explicitly set to the corresponding 4-bit format and the prefetch length 211 tuned to the latency characteristics of the memory 101.

Upon execution of the TENSORSTREAM instruction, the descriptor FSM 105 initiates the retrieval process, and the prefetch scheduler 107 ensures that a continuous stream of compressed blocks 110 is delivered to the stream decompressor 109. The stream decompressor 109 operates at wire speed to expand the 4-bit compressed weights into 16-bit Brain Floating Point (BF16) values or 16-bit floating point (FP16) values, which are the native formats required by the matrix hardware 117 for high-precision accumulation. This on-the-fly expansion allows the matrix hardware 117, such as a specialized matrix processing unit (MPU) or a systolic array, to operate at near-peak computational efficiency, as the effective bandwidth provided by the matrix data micro-engine 102 matches the consumption rate of the arithmetic logic units. Without this mechanism, the matrix hardware 117 would spend a significant portion of cycles stalling while waiting for uncompressed weights to traverse the memory hierarchy. Furthermore, the activation/residual/store unit 119 may be configured to perform post-processing, such as applying a GeLU activation function, before writing the results back, thereby keeping the entire heavy-weight FFN operation within the accelerated domain.

In a second exemplary scenario, the apparatus is applied to Embedding Table Lookups within the context of large-scale recommendation systems, such as Deep Learning Recommendation Models (DLRM). These workloads are characterized by massive embedding tables that far exceed the capacity of on-chip caches, necessitating frequent random accesses to the memory 101. In this scenario, the embedding vectors are stored as compressed blocks 110 utilizing a sparse representation to capitalize on the fact that many features in the input vector are zero. The descriptor 103 is configured with a sparse mask format 207 that indicates the specific encoding of the sparsity metadata, such as a bitmask or a coordinate list. When a lookup operation is required, the matrix data micro-engine 102 retrieves the relevant compressed blocks 110 containing the sparse rows. The sparsity mask decoder 111 then plays a critical role by interpreting the metadata to identify the location of non-zero elements.

If the downstream matrix hardware 117 supports sparse inputs, the sparsity mask decoder 111 emits index/value pairs directly into the matrix buffer(s) 113, allowing the matrix hardware 117 to perform a “gather” operation or a sparse matrix-vector multiplication efficiently. Conversely, if the matrix hardware 117 expects dense vectors, the sparsity mask decoder 111 operates in a dense expansion mode, automatically inserting zero values into the stream to reconstruct the full embedding vector before it is placed in the matrix buffer(s) 113. This capability decouples the storage format of the embedding tables from the execution format of the hardware, allowing the system to store embeddings in a highly compressed, sparse format to save capacity in the memory 101 and reduce bus contention, while still serving dense vectors to the compute units if necessary. This significantly improves the throughput of the recommendation engine by maximizing the effective utilization of the available memory bandwidth and cache capacity.

In a third exemplary scenario, the apparatus is deployed in an Edge AI Processing environment, such as a mobile device or an Internet-of-Things (IoT) endpoint, where power consumption and thermal constraints are paramount. In such devices, the memory 101 is typically implemented as Low-Power Double Data Rate (LPDDR) memory, which has lower bandwidth compared to server-class HBM. To enable the execution of high-fidelity models (e.g., Llama-7B or Stable Diffusion) on these constrained devices, the model weights are quantized using aggressive non-linear quantization schemes, such as Product Quantization (PQ) or Vector Quantization (VQ), often reducing the representation to as little as 2 to 3 bits per weight. The descriptor 103 for these operations includes a valid codebook pointer 215, which directs the matrix data micro-engine 102 to a shared codebook stored in a small, fast region of the memory 101 or an on-chip scratchpad.

During execution, the stream decompressor 109 utilizes the indices fetched from the compressed blocks 110 to perform lookups into the codebook referenced by the codebook pointer 215. This lookup process reconstructs the approximate floating-point values of the weights locally within the matrix data micro-engine 102. By transmitting only 2-bit or 3-bit indices across the memory bus and reconstructing the 16-bit values immediately prior to computation, the system achieves a substantial reduction in the energy cost per inference, as the energy required to drive the external memory interface is often orders of magnitude higher than the energy required for on-chip arithmetic or SRAM access. This architecture enables the edge device to run complex neural networks that would otherwise be prohibited by the bandwidth and power limitations of the platform, effectively bringing server-class AI capabilities to the edge. The matrix buffer(s) 113 buffer these reconstructed weights, smoothing out any irregularities in the decompression latency and ensuring that the low-power matrix hardware 117 is kept supplied with data during active-duty cycles, allowing for rapid return to sleep states between inferences.

### Example Architectures

Detailed below are descriptions of example computer architectures. Other system designs and configurations known in the arts for laptop, desktop, and handheld personal computers (PC) s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

### Example Systems

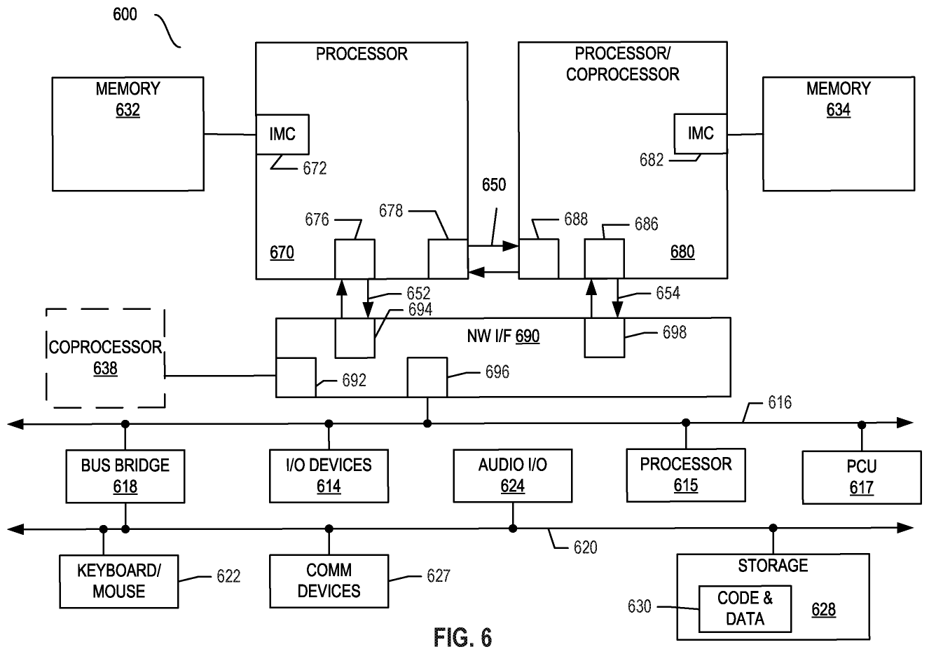

FIG. 6 illustrates an example computing system. Multiprocessor system 600 is an interfaced system and includes a plurality of processors or cores including a first processor 670 and a second processor 680 coupled via an interface 650 such as a point-to-point (P-P) interconnect, a fabric, and/or bus. In some examples, the first processor 670 and the second processor 680 are homogeneous. In some examples, first processor 670 and the second processor 680 are heterogenous. Though the example multiprocessor system 600 is shown to have two processors, the system may have three or more processors, or may be a single processor system. In some examples, the computing system is a system on a chip (SoC).

Processors 670 and 680 are shown including integrated memory controller (IMC) circuitry 672 and 682, respectively. Processor 670 also includes interface circuits 676 and 678; similarly, second processor 680 includes interface circuits 686 and 688. Processors 670, 680 may exchange information via the interface 650 using interface circuits 678, 688. IMCs 672 and 682 couple the processors 670, 680 to respective memories, namely a memory 632 and a memory 634, which may be portions of main memory locally attached to the respective processors.

Processors 670, 680 may each exchange information with a network interface (NW I/F) 690 via individual interfaces 652, 654 using interface circuits 676, 694, 686, 698. The network interface 690 (e.g., one or more of an interconnect, bus, and/or fabric, and in some examples is a chipset) may optionally exchange information with a co-processor 638 via an interface circuit 692. In some examples, the co-processor 638 is a special-purpose processor, such as, for example, a high-throughput processor, a network or communication processor, a compression engine, a graphics processor, a general purpose graphics processing unit (GPGPU), a neural-network processing unit (NPU), an embedded processor, a security processor, a cryptographic accelerator, a matrix accelerator, an in-memory analytics accelerator, a data streaming accelerator, data graph operations, or the like.

A shared cache (not shown) may be included in either processor 670, 680 or outside of both processors, yet connected with the processors via an interface such as P-P interconnect, such that either or both processors' local cache information may be stored in the shared cache if a processor is placed into a low power mode.

Network interface 690 may be coupled to a first interface 616 via interface circuit 696. In some examples, first interface 616 may be an interface such as a Peripheral Component Interconnect (PCI) interconnect, a PCI Express interconnect or another I/O interconnect. In some examples, first interface 616 is coupled to a power control unit (PCU) 617, which may include circuitry, software, and/or firmware to perform power management operations with regard to the processors 670, 680 and/or co-processor 638. PCU 617 provides control information to a voltage regulator (not shown) to cause the voltage regulator to generate the appropriate regulated voltage. PCU 617 also provides control information to control the operating voltage generated. In various examples, PCU 617 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 617 is illustrated as being present as logic separate from the processor 670 and/or processor 680. In other cases, PCU 617 may execute on a given one or more of cores (not shown) of processor 670 or 680. In some cases, PCU 617 may be implemented as a microcontroller (dedicated or general-purpose) or other control logic configured to execute its own dedicated power management code, sometimes referred to as P-code. In yet other examples, power management operations to be performed by PCU 617 may be implemented externally to a processor, such as by way of a separate power management integrated circuit (PMIC) or another component external to the processor. In yet other examples, power management operations to be performed by PCU 617 may be implemented within BIOS or other system software.

Various I/O devices 614 may be coupled to first interface 616, along with a bus bridge 618 which couples first interface 616 to a second interface 620. In some examples, one or more additional processor(s) 615, such as co-processors, high throughput many integrated core (MIC) processors, GPGPUs, accelerators (such as graphics accelerators or digital signal processing (DSP) units), field programmable gate arrays (FPGAs), or any other processor, are coupled to first interface 616. In some examples, second interface 620 may be a low pin count (LPC) interface. Various devices may be coupled to second interface 620 including, for example, a keyboard and/or mouse 622, communication devices 627 and storage circuitry 628. Storage circuitry 628 may be one or more non-transitory machine-readable storage media as described below, such as a disk drive or other mass storage device which may include instructions/code and data 630 and may implement the storage 503 in some examples. Further, an audio I/O 624 may be coupled to second interface 620. Note that other architectures than the point-to-point architecture described above are possible. For example, instead of the point-to-point architecture, a system such as multiprocessor system 600 may implement a multi-drop interface or other such architecture.

### Example Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a co-processor including one or more special purpose cores intended primarily for graphics and/or scientific (throughput) computing. Such different processors lead to different computer system architectures, which may include: 1) the co-processor on a separate chip from the CPU; 2) the co-processor on a separate die in the same package as a CPU; 3) the co-processor on the same die as a CPU (in which case, such a co-processor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described co-processor, and additional functionality. Example core architectures are described next, followed by descriptions of example processors and computer architectures.

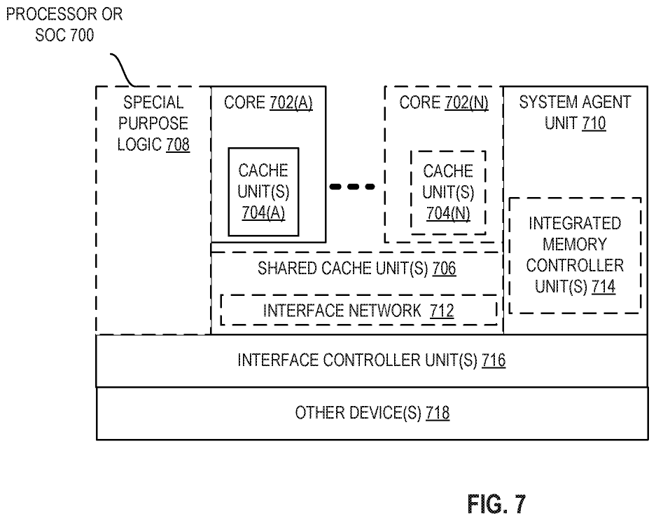

FIG. 7 illustrates a block diagram of an example processor and/or SoC 700 that may have one or more cores and an integrated memory controller. The solid lined boxes illustrate a processor and/or SoC 700 with a single core 702(A), system agent unit circuitry 710, and a set of one or more interface controller unit(s) circuitry 716, while the optional addition of the dashed lined boxes illustrates an alternative processor and/or SoC 700 with multiple cores 702(A)-(N), a set of one or more integrated memory controller unit(s) circuitry 714 in the system agent unit circuitry 710, and special purpose logic 708, as well as a set of one or more interface controller unit(s) circuitry 716. Note that the processor and/or SoC 700 may be one of the processors 670 or 680, or co-processor 638 or 615 of FIG. 6.

Thus, different implementations of the processor and/or SoC 700 may include: 1) a CPU with the special purpose logic 708 being a high-throughput processor, a network or communication processor, a compression engine, a graphics processor, a general purpose graphics processing unit (GPGPU), a neural-network processing unit (NPU), an embedded processor, a security processor, a matrix accelerator, an in-memory analytics accelerator, a compression accelerator, a data streaming accelerator, data graph operations, or the like (which may include one or more cores, not shown), and the cores 702(A)-(N) being one or more general purpose cores (e.g., general purpose in-order cores, general purpose out-of-order cores, or a combination of the two); 2) a co-processor with the cores 702(A)-(N) being a large number of special purpose cores intended primarily for graphics and/or scientific (throughput); and 3) a co-processor with the cores 702(A)-(N) being a large number of general purpose in-order cores. Thus, the processor and/or SoC 700 may be a general-purpose processor, co-processor or special-purpose processor, such as, for example, a network or communication processor, compression engine, graphics processor, GPGPU (general purpose graphics processing unit), a high throughput many integrated core (MIC) co-processor (including 30 or more cores), embedded processor, or the like. The processor may be implemented on one or more chips. The processor and/or SoC 700 may be a part of and/or may be implemented on one or more substrates using any of a number of process technologies, such as, for example, complementary metal oxide semiconductor (CMOS), bipolar CMOS (BICMOS), P-type metal oxide semiconductor (PMOS), or N-type metal oxide semiconductor (NMOS).

A memory hierarchy includes one or more levels of cache unit(s) circuitry 704(A)-(N) within the cores 702(A)-(N), a set of one or more shared cache unit(s) circuitry 706, and external memory (not shown) coupled to the set of integrated memory controller unit(s) circuitry 714. The set of one or more shared cache unit(s) circuitry 706 may include one or more mid-level caches, such as level 2 (L2), level 3 (L3), level 4 (L4), or other levels of cache, such as a last level cache (LLC), and/or combinations thereof. While in some examples interface network circuitry 712 (e.g., a ring interconnect) interfaces the special purpose logic 708 (e.g., integrated graphics logic), the set of shared cache unit(s) circuitry 706, and the system agent unit circuitry 710, alternative examples use any number of well-known techniques for interfacing such units. In some examples, coherency is maintained between one or more of the shared cache unit(s) circuitry 706 and cores 702(A)-(N). In some examples, interface controller unit(s) circuitry 716 couple the cores 702(A)-(N) to one or more other devices 718 such as one or more I/O devices, storage, one or more communication devices (e.g., wireless networking, wired networking, etc.), etc.

In some examples, one or more of the cores 702(A)-(N) are capable of multi-threading. The system agent unit circuitry 710 includes those components coordinating and operating cores 702(A)-(N). The system agent unit circuitry 710 may include, for example, power control unit (PCU) circuitry and/or display unit circuitry (not shown). The PCU may be or may include logic and components needed for regulating the power state of the cores 702(A)-(N) and/or the special purpose logic 708 (e.g., integrated graphics logic). The display unit circuitry is for driving one or more externally connected displays.

The cores 702(A)-(N) may be homogenous in terms of instruction set architecture (ISA). Alternatively, the cores 702(A)-(N) may be heterogeneous in terms of ISA; that is, a subset of the cores 702(A)-(N) may be capable of executing an ISA, while other cores may be capable of executing only a subset of that ISA or another ISA.

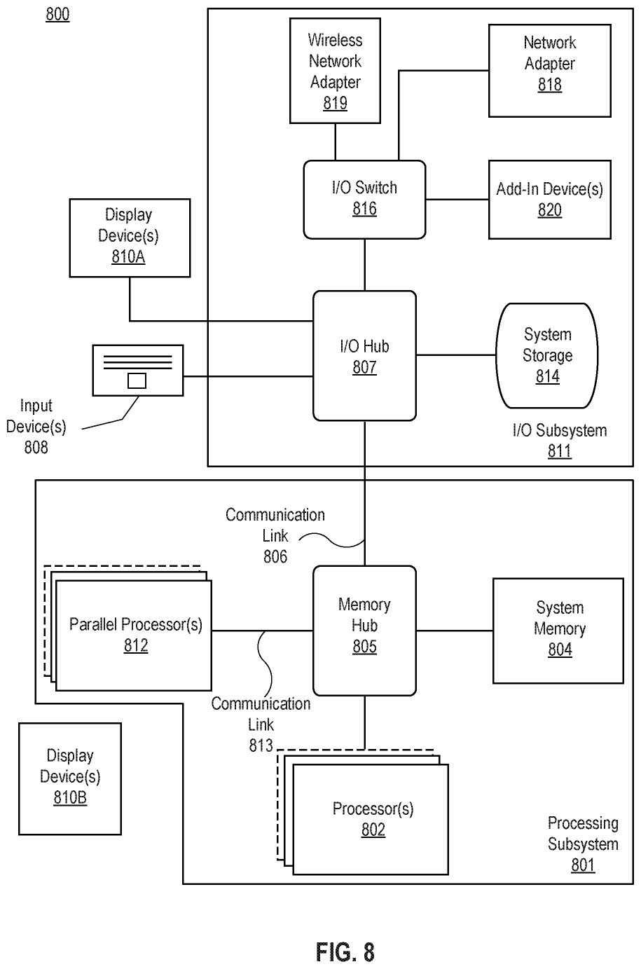

FIG. 8 is a block diagram illustrating a computing system 800 configured to implement one or more aspects of the examples described herein. The computing system 800 includes a processing subsystem 801 having one or more processor(s) 802 and a system memory 804 communicating via an interconnection path that may include a memory hub 805. The memory hub 805 may be a separate component within a chipset component or may be integrated within the one or more processor(s) 802. The memory hub 805 couples with an I/O subsystem 811 via a communication link 806. The I/O subsystem 811 includes an I/O hub 807 that can enable the computing system 800 to receive input from one or more input device(s) 808. Additionally, the I/O hub 807 can enable a display controller, which may be included in the one or more processor(s) 802, to provide outputs to one or more display device(s) 810A. In some examples the one or more display device(s) 810A coupled with the I/O hub 807 can include a local, internal, or embedded display device.

The processing subsystem 801, for example, includes one or more parallel processor(s) 812 coupled to memory hub 805 via a bus or communication link 813. The communication link 813 may be one of any number of standards-based communication link technologies or protocols, such as, but not limited to PCI Express, or may be a vendor specific communications interface or communications fabric. The one or more parallel processor(s) 812 may form a computationally focused parallel or vector processing system that can include a large number of processing cores and/or processing clusters, such as a many integrated core (MIC) processor. For example, the one or more parallel processor(s) 812 form a graphics processing subsystem that can output pixels to one of the one or more display device(s) 810A coupled via the I/O hub 807. The one or more parallel processor(s) 812 can also include a display controller and display interface (not shown) to enable a direct connection to one or more display device(s) 810B.

Within the I/O subsystem 811, a system storage unit 814 can connect to the I/O hub 807 to provide a storage mechanism for the computing system 800. An I/O switch 816 can be used to provide an interface mechanism to enable connections between the I/O hub 807 and other components, such as a network adapter 818 and/or wireless network adapter 819 that may be integrated into the platform, and various other devices that can be added via one or more add-in device(s) 820. The add-in device(s) 820 may also include, for example, one or more external graphics processor devices, graphics cards, and/or compute accelerators. The network adapter 818 can be an Ethernet adapter or another wired network adapter. The wireless network adapter 819 can include one or more of a Wi-Fi, Bluetooth, near field communication (NFC), or other network device that includes one or more wireless radios.

The computing system 800 can include other components not explicitly shown, including USB or other port connections, optical storage drives, video capture devices, and the like, which may also be connected to the I/O hub 807. Communication paths interconnecting the various components in FIG. 8 may be implemented using any suitable protocols, such as PCI (Peripheral Component Interconnect) based protocols (e.g., PCI-Express), or any other bus or point-to-point communication interfaces and/or protocol(s), such as the NVLink high-speed interconnect, Compute Express Link™ (CXL™) (e.g., CXL.mem), Infinity Fabric (IF), Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (ROCE), Intel QuickPath Interconnect (QPI), Intel Ultra Path Interconnect (UPI), Intel On-Chip System Fabric (IOSF), Omnipath, HyperTransport, Advanced Microcontroller Bus Architecture (AMBA) interconnect, OpenCAPI, Gen-Z, Cache Coherent Interconnect for Accelerators (CCIX), 3GPP Long Term Evolution (LTE) (4G), 3GPP 5G, and variations thereof, or wired or wireless interconnect protocols known in the art. In some examples, data can be copied or stored to virtualized storage nodes using a protocol such as non-volatile memory express (NVMe) over Fabrics (NVMe-oF) or NVMe.

The one or more parallel processor(s) 812 may incorporate circuitry optimized for graphics and video processing, including, for example, video output circuitry, and constitutes a graphics processing unit (GPU). Alternatively or additionally, the one or more parallel processor(s) 812 can incorporate circuitry optimized for general purpose processing, while preserving the underlying computational architecture, described in greater detail herein. Components of the computing system 800 may be integrated with one or more other system elements on a single integrated circuit. For example, the one or more parallel processor(s) 812, memory hub 805, processor(s) 802, and I/O hub 807 can be integrated into a system on chip (SoC) integrated circuit. Alternatively, the components of the computing system 800 can be integrated into a single package to form a system in package (SIP) configuration. In some examples at least a portion of the components of the computing system 800 can be integrated into a multi-chip module (MCM), which can be interconnected with other multi-chip modules into a modular computing system.

It will be appreciated that the computing system 800 shown herein is illustrative and that variations and modifications are possible. The connection topology, including the number and arrangement of bridges, the number of processor(s) 802, and the number of parallel processor(s) 812, may be modified as desired. For instance, system memory 804 can be connected to the processor(s) 802 directly rather than through a bridge, while other devices communicate with system memory 804 via the memory hub 805 and the processor(s) 802. In other alternative topologies, the parallel processor(s) 812 are connected to the I/O hub 807 or directly to one of the one or more processor(s) 802, rather than to the memory hub 805. In other examples, the I/O hub 807 and memory hub 805 may be integrated into a single chip. It is also possible that two or more sets of processor(s) 802 are attached via multiple sockets, which can couple with two or more instances of the parallel processor(s) 812.

Some of the particular components shown herein are optional and may not be included in all implementations of the computing system 800. For example, any number of add-in cards or peripherals may be supported, or some components may be eliminated. Furthermore, some architectures may use different terminology for components similar to those illustrated in FIG. 8. For example, the memory hub 805 may be referred to as a Northbridge in some architectures, while the I/O hub 807 may be referred to as a Southbridge.

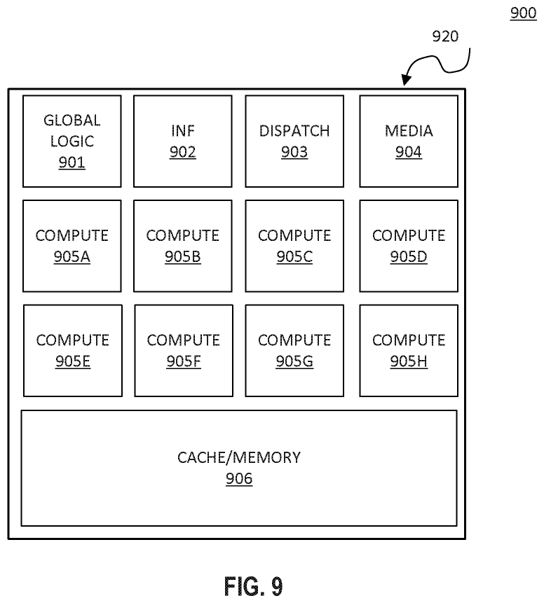

FIG. 9 shows a parallel compute system 900, according to some examples. In some examples the parallel compute system 900 includes a parallel processor 920, which can be a graphics processor or compute accelerator as described herein. The parallel processor 920 includes a global logic unit 901, an interface 902, a thread dispatcher 903, a media unit 904, a set of compute units 905A-905H, and a cache/memory units 906. The global logic unit 901, in some examples, includes global functionality for the parallel processor 920, including device configuration registers, global schedulers, power management logic, and the like. The interface 902 can include a front-end interface for the parallel processor 920. The thread dispatcher 903 can receive workloads from the interface 902 and dispatch threads for the workload to the compute units 905A-905H. If the workload includes any media operations, at least a portion of those operations can be performed by the media unit 904. The media unit can also offload some operations to the compute units 905A-905H. The cache/memory units 906 can include cache memory (e.g., L3 cache) and local memory (e.g., HBM, GDDR) for the parallel processor 920. Compute units 905 may include units for one or more of a network or communication processor, a core, a graphics processor, a general purpose graphics processing unit (GPGPU), a neural-network processing unit (NPU), an embedded processor, a security processor, a cryptographic accelerator, a matrix accelerator, an in-memory analytics accelerator, a compression accelerator, a data streaming accelerator, or the like.

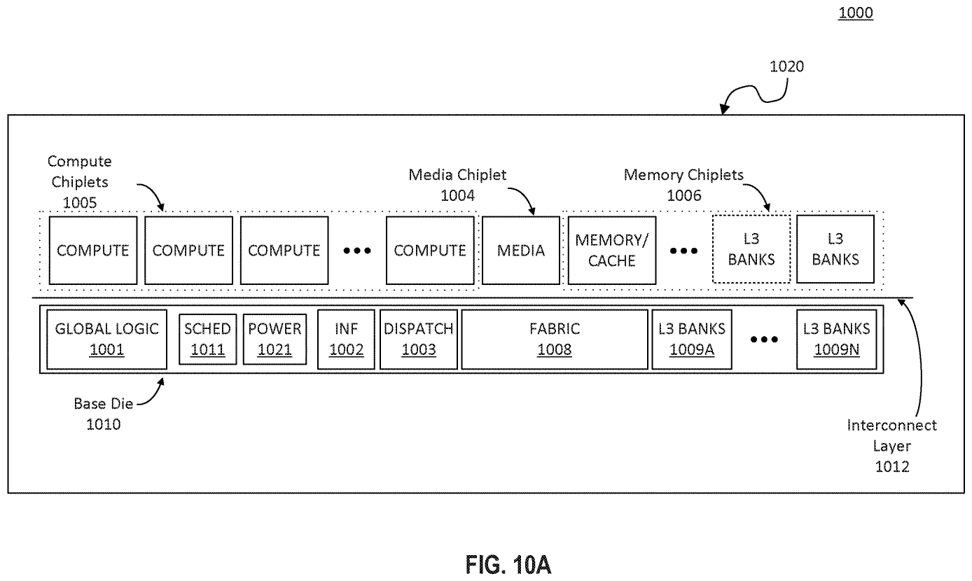

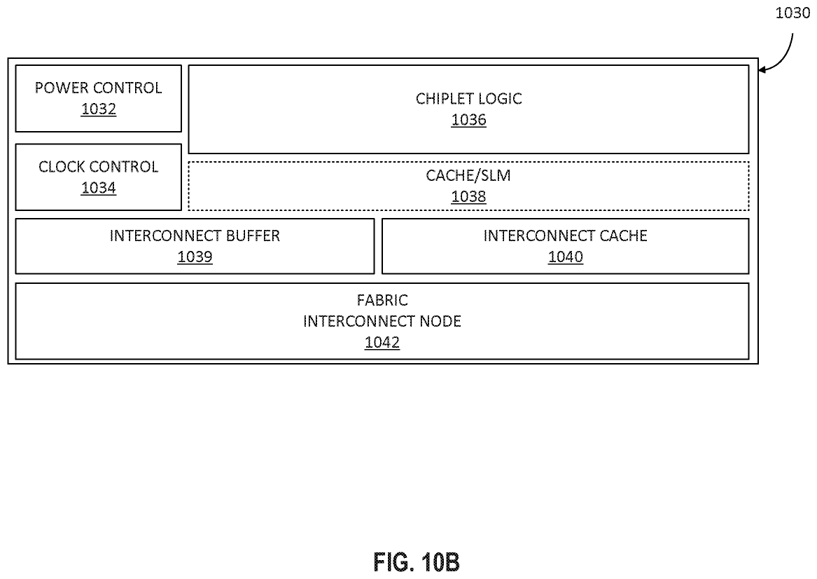

FIGS. 10A-10B illustrate a hybrid logical/physical view of a disaggregated parallel processor, according to examples described herein. FIG. 10A illustrates a disaggregated parallel compute system 1000. FIG. 10B illustrates a chiplet 1030 of the disaggregated parallel compute system 1000.

As shown in FIG. 10A, a disaggregated parallel compute system 1000 can include a parallel processor 1020 in which the various components of the parallel processor SOC are distributed across multiple chiplets. Each chiplet can be a distinct IP core that is independently designed and configured to communicate with other chiplets via one or more common interfaces. The chiplets include but are not limited to compute chiplets 1005, a media chiplet 1004, and memory chiplets 1006. Each chiplet can be separately manufactured using different process technologies. For example, compute chiplets 1005 may be manufactured using the smallest or most advanced process technology available at the time of fabrication, while memory chiplets 1006 or other chiplets (e.g., I/O, networking, etc.) may be manufactured using a larger or less advanced process technologies.

The various chiplets can be bonded to a base die 1010 and configured to communicate with each other and logic within the base die 1010 via an interconnect layer 1012. In some examples, the base die 1010 can include global logic 1001, which can include scheduler 1011 and power management 1021 logic units, an interface 1002, a dispatch unit 1003, and an interconnect fabric 1008 coupled with or integrated with one or more L3 cache banks 1009A-1009N. The interconnect fabric 1008 can be an inter-chiplet fabric that is integrated into the base die 1010. Logic chiplets can use the fabric 1008 to relay messages between the various chiplets. Additionally, L3 cache banks 1009A-1009N in the base die and/or L3 cache banks within the memory chiplets 1006 can cache data read from and transmitted to DRAM chiplets within the memory chiplets 1006 and to system memory of a host.

In some examples the global logic 1001 is a microcontroller that can execute firmware to perform scheduler 1011 and power management 1021 functionality for the parallel processor 1020. The microcontroller that executes the global logic can be tailored for the target use case of the parallel processor 1020. The scheduler 1011 can perform global scheduling operations for the parallel processor 1020. The power management 1021 functionality can be used to enable or disable individual chiplets within the parallel processor when those chiplets are not in use.

The various chiplets of the parallel processor 1020 can be designed to perform specific functionality that, in existing designs, would be integrated into a single die. A set of compute chiplets 1005 can include clusters of compute units (e.g., execution units, streaming multiprocessors, etc.) that include programmable logic to execute compute or graphics shader instructions. A media chiplet 1004 can include hardware logic to accelerate media encode and decode operations. Memory chiplets 1006 can include volatile memory (e.g., DRAM) and one or more SRAM cache memory banks (e.g., L3 banks).

As shown in FIG. 10B, each chiplet 1030 can include common components and application specific components. Chiplet logic 1036 within the chiplet 1030 can include the specific components of the chiplet, such as an array of streaming multiprocessors, compute units, or execution units described herein. The chiplet logic 1036 can couple with an optional cache or shared local memory 1038 or can include a cache or shared local memory within the chiplet logic 1036. The chiplet 1030 can include a fabric interconnect node 1042 that receives commands via the inter-chiplet fabric. Commands and data received via the fabric interconnect node 1042 can be stored temporarily within an interconnect buffer 1039. Data transmitted to and received from the fabric interconnect node 1042 can be stored in an interconnect cache 1040. Power control 1032 and clock control 1034 logic can also be included within the chiplet. The power control 1032 and clock control 1034 logic can receive configuration commands via the fabric can configure dynamic voltage and frequency scaling for the chiplet 1030. In some examples, each chiplet can have an independent clock domain and power domain and can be clock gated and power gated independently of other chiplets.

At least a portion of the components within the illustrated chiplet 1030 can also be included within logic embedded within the base die 1010 of FIG. 10A. For example, logic within the base die that communicates with the fabric can include a version of the fabric interconnect node 1042. Base die logic that can be independently clock or power gated can include a version of the power control 1032 and/or clock control 1034 logic.

Thus, while various examples described herein use the term SOC to describe a device or system having a processor and associated circuitry (e.g., Input/Output (“I/O”) circuitry, power delivery circuitry, memory circuitry, etc.) integrated monolithically into a single Integrated Circuit (“IC”) die, or chip, the present disclosure is not limited in that respect. For example, in various examples of the present disclosure, a device or system can have one or more processors (e.g., one or more processor cores) and associated circuitry (e.g., Input/Output (“I/O”) circuitry, power delivery circuitry, etc.) arranged in a disaggregated collection of discrete dies, tiles and/or chiplets (e.g., one or more discrete processor core die arranged adjacent to one or more other die such as memory die, I/O die, etc.). In such disaggregated devices and systems the various dies, tiles and/or chiplets can be physically and electrically coupled together by a package structure including, for example, various packaging substrates, interposers, active interposers, photonic interposers, interconnect bridges and the like. The disaggregated collection of discrete dies, tiles, and/or chiplets can also be part of a System-on-Package (“SoP”).”

Example Core Architectures-In-order and out-of-order core block diagram.

FIG. 11(A) is a block diagram illustrating both an example in-order pipeline and an example register renaming, out-of-order issue/execution pipeline according to examples. FIG. 11(B) is a block diagram illustrating both an example in-order architecture core and an example register renaming, out-of-order issue/execution architecture core to be included in a processor according to examples. The solid lined boxes in FIGS. 11(A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 11(A), a processor pipeline 1100 includes a fetch stage 1102, an optional length decoding stage 1104, a decode stage 1106, an optional allocation (Alloc) stage 1108, an optional renaming stage 1110, a schedule (also known as a dispatch or issue) stage 1112, an optional register read/memory read stage 1114, an execute stage 1116, a write back/memory write stage 1118, an optional exception handling stage 1122, and an optional commit stage 1124. One or more operations can be performed in each of these processor pipeline stages. For example, during the fetch stage 1102, one or more instructions are fetched from instruction memory, and during the decode stage 1106, the one or more fetched instructions may be decoded, addresses (e.g., load store unit (LSU) addresses) using forwarded register ports may be generated, and branch forwarding (e.g., immediate offset or a link register (LR)) may be performed. In some examples, the decode stage 1106 and the register read/memory read stage 1114 may be combined into one pipeline stage. In some examples, during the execute stage 1116, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 11(B) may implement the pipeline 1100 as follows: 1) the instruction fetch circuitry 1138 performs the fetch and length decoding stages 1102 and 1104; 2) the decode circuitry 1140 performs the decode stage 1106; 3) the rename/allocator unit circuitry 1152 performs the allocation stage 1108 and renaming stage 1110; 4) the scheduler(s) circuitry 1156 performs the schedule stage 1112; 5) the physical register file(s) circuitry 1158 and the memory unit circuitry 1170 perform the register read/memory read stage 1114; the execution cluster(s) 1160 perform the execute stage 1116; 6) the memory unit circuitry 1170 and the physical register file(s) circuitry 1158 perform the write back/memory write stage 1118; 7) various circuitry may be involved in the exception handling stage 1122; and 8) the retirement unit circuitry 1154 and the physical register file(s) circuitry 1158 perform the commit stage 1124.

FIG. 11(B) shows a processor core 1190 including front-end unit circuitry 1130 coupled to execution engine unit circuitry 1150, and both are coupled to memory unit circuitry 1170. The core 1190 may be a reduced instruction set architecture computing (RISC) core, a complex instruction set architecture computing (CISC) core, a very long instruction word (VLIW) core, or a hybrid or alternative core type. As yet another option, the core 1190 may be a special-purpose core, such as, for example, a network or communication core, compression engine, co-processor core, general purpose computing graphics processing unit (GPGPU) core, graphics core, or the like.

The front-end unit circuitry 1130 may include branch prediction circuitry 1132 coupled to instruction cache circuitry 1134, which is coupled to an instruction translation lookaside buffer (TLB) 1136, which is coupled to instruction fetch circuitry 1138, which is coupled to decode circuitry 1140. In some examples, the instruction cache circuitry 1134 is included in the memory unit circuitry 1170 rather than the front-end unit circuitry 1130. The decode circuitry 1140 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 1140 may further include address generation unit (AGU, not shown) circuitry. In some examples, the AGU generates an LSU address using forwarded register ports, and may further perform branch forwarding (e.g., immediate offset branch forwarding, LR register branch forwarding, etc.). The decode circuitry 1140 may be implemented using various different mechanisms. Examples of suitable mechanisms include, but are not limited to, look-up tables, hardware implementations, programmable logic arrays (PLAs), microcode read only memories (ROMs), etc. In some examples, the core 1190 includes a microcode ROM (not shown) or other medium that stores microcode for certain macroinstructions (e.g., in decode circuitry 1140 or otherwise within the front-end unit circuitry 1130). In some examples, the decode circuitry 1140 includes a micro-operation (micro-op) or operation cache (not shown) to hold/cache decoded operations, micro-tags, or micro-operations generated during the decode or other stages of the processor pipeline 1100. The decode circuitry 1140 may be coupled to rename/allocator unit circuitry 1152 in the execution engine unit circuitry 1150.

The execution engine unit circuitry 1150 includes the rename/allocator unit circuitry 1152 coupled to retirement unit circuitry 1154 and a set of one or more scheduler(s) circuitry 1156. The scheduler(s) circuitry 1156 represents any number of different schedulers, including reservations stations, central instruction window, etc. In some examples, the scheduler(s) circuitry 1156 can include arithmetic logic unit (ALU) scheduler/scheduling circuitry, ALU queues, address generation unit (AGU) scheduler/scheduling circuitry, AGU queues, etc. The scheduler(s) circuitry 1156 is coupled to the physical register file(s) circuitry 1158. Each of the physical register file(s) circuitry 1158 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In some examples, the physical register file(s) circuitry 1158 includes vector registers unit circuitry, writemask registers unit circuitry, and scalar register unit circuitry. These register units may provide architectural vector registers, vector mask registers, general-purpose registers, etc. The physical register file(s) circuitry 1158 is coupled to the retirement unit circuitry 1154 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 1154 and the physical register file(s) circuitry 1158 are coupled to the execution cluster(s) 1160. The execution cluster(s) 1160 includes a set of one or more execution unit(s) circuitry 1162 and a set of one or more memory access circuitry 1164. The execution unit(s) circuitry 1162 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). In some examples, execution unit(s) circuitry 1162 may include hardware to support functionality for instructions for one or more of a compression engine, graphics processing, neural-network processing, in-memory analytics, matrix operations, cryptographic operations, data streaming operations, data graph operations, etc.

While some examples may include a number of execution units or execution unit circuitry dedicated to specific functions or sets of functions, other examples may include only one execution unit circuitry or multiple execution units/execution unit circuitry that all perform all functions. The scheduler(s) circuitry 1156, physical register file(s) circuitry 1158, and execution cluster(s) 1160 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster- and in the case of a separate memory access pipeline, certain examples are implemented in which only the execution cluster of this pipeline has the memory access unit(s) circuitry 1164). It should also be understood that where separate pipelines are used, one or more of these pipelines may be out-of-order issue/execution and the rest in-order.

In some examples, the execution engine unit circuitry 1150 may perform load store unit (LSU) address/data pipelining to an Advanced Microcontroller Bus (AMB) interface (not shown), and address phase and writeback, data phase load, store, and branches.

The set of memory access circuitry 1164 is coupled to the memory unit circuitry 1170, which includes data TLB circuitry 1172 coupled to data cache circuitry 1174 coupled to level 2 (L2) cache circuitry 1176. In some examples, the memory access circuitry 1164 may include load unit circuitry, store address unit circuitry, and store data unit circuitry, each of which is coupled to the data TLB circuitry 1172 in the memory unit circuitry 1170. The instruction cache circuitry 1134 is further coupled to the level 2 (L2) cache circuitry 1176 in the memory unit circuitry 1170. In some examples, the instruction cache 1134 and the data cache 1174 are combined into a single instruction and data cache (not shown) in L2 cache circuitry 1176, level 3 (L3) cache circuitry (not shown), and/or main memory. The L2 cache circuitry 1176 is coupled to one or more other levels of cache and eventually to a main memory.

The core 1190 may support one or more instructions sets (e.g., the x86 instruction set architecture (optionally with some extensions that have been added with newer versions); the MIPS instruction set architecture; the ARM instruction set architecture (optionally with optional additional extensions such as NEON, etc.); RISC instruction set architecture), including the instruction(s) described herein. In some examples, the core 1190 includes logic to support a packed data instruction set architecture extension (e.g., AVX1, AVX2, AVX512, AMX, etc.), thereby allowing the operations used by many multimedia applications to be performed using packed data.

### Example Execution Unit(s) Circuitry.

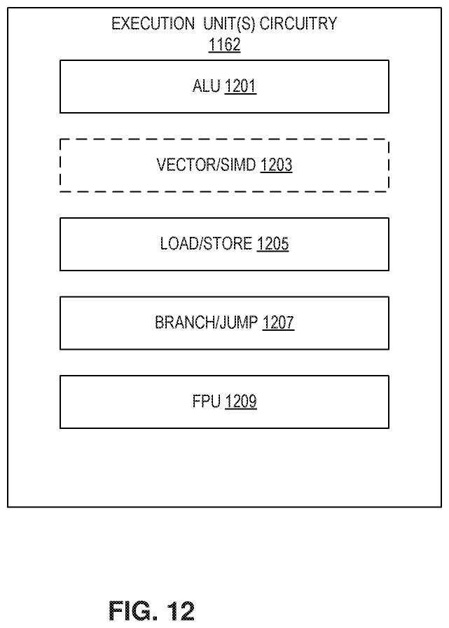

FIG. 12 illustrates examples of execution unit(s) circuitry, such as execution unit(s) circuitry 1162 of FIG. 11(B). As illustrated, execution unit(s) circuitry 1162 may include one or more ALU circuits 1201, optional vector/single instruction multiple data (SIMD) circuits 1203, load/store circuits 1205, branch/jump circuits 1207, and/or Floating-point unit (FPU) circuits 1209. ALU circuits 1201 perform integer arithmetic and/or Boolean operations. Vector/SIMD circuits 1203 perform vector/SIMD operations on packed data (such as SIMD/vector registers). Load/store circuits 1205 execute load and store instructions to load data from memory into registers or store from registers to memory. Load/store circuits 1205 may also generate addresses. Branch/jump circuits 1207 cause a branch or jump to a memory address depending on the instruction. FPU circuits 1209 perform floating-point arithmetic. The width of the execution unit(s) circuitry 1162 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Example Register Architecture.

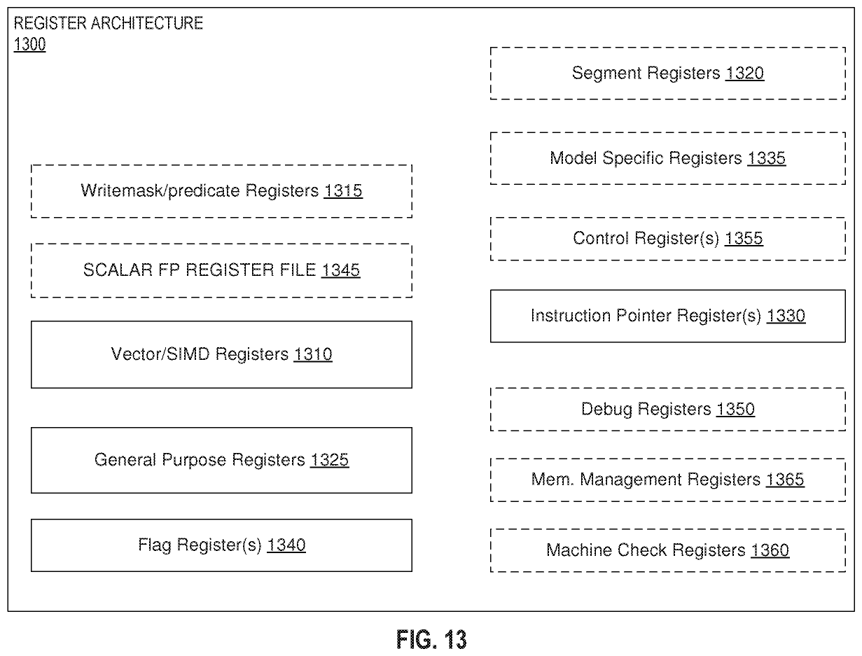

FIG. 13 is a block diagram of a register architecture 1300 according to some examples. As illustrated, the register architecture 1300 includes vector/SIMD registers 1310 that vary from 128-bit to 1,024 bits width. In some examples, the vector/SIMD registers 1310 are physically 512-bits and, depending upon the mapping, only some of the lower bits are used. For example, in some examples, the vector/SIMD registers 1310 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 1300 includes writemask/predicate registers 1315. For example, in some examples, there are 8 writemask/predicate registers (sometimes called k0 through k7) that are each 16-bit, 32-bit, 64-bit, or 128-bit in size. Writemask/predicate registers 1315 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 1315 corresponds to a data element position of the destination. In other examples, the writemask/predicate registers 1315 are scalable and consists of a set number of enable bits for a given vector element (e.g., 8 enable bits per 64-bit vector element).

The register architecture 1300 includes a plurality of general-purpose registers 1325. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 1300 includes scalar floating-point (FP) register file 1345 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 1340 (e.g., EFLAGS, RFLAGS, etc.) store status and control information for arithmetic, compare, and system operations. For example, the one or more flag registers 1340 may store condition code information such as carry, parity, auxiliary carry, zero, sign, and overflow. In some examples, the one or more flag registers 1340 are called program status and control registers.

Segment registers 1320 contain segment points for use in accessing memory. In some examples, these registers are referenced by the names CS, DS, SS, ES, FS, and GS.

Model specific registers or machine specific registers (MSRs) 1335 control and report on processor performance. Most MSRs 1335 handle system-related functions and are not accessible to an application program. For example, MSRs may provide control for one or more of: performance-monitoring counters, debug extensions, memory type range registers, thermal and power management, instruction-specific support, and/or processor feature/mode support. Machine check registers 1360 consist of control, status, and error reporting MSRs that are used to detect and report on hardware errors. Control register(s) 1355 (e.g., CR0-CR4) determine the operating mode of a processor (e.g., processor 670, 680, 638, 615, and/or 700) and the characteristics of a currently executing task. In some examples, MSRs 1335 are a subset of control registers 1355.

One or more instruction pointer register(s) 1330 store an instruction pointer value. Debug registers 1350 control and allow for the monitoring of a processor or core's debugging operations.

Memory (mem) management registers 1365 specify the locations of data structures used in protected mode memory management. These registers may include a global descriptor table register (GDTR), interrupt descriptor table register (IDTR), task register, and a local descriptor table register (LDTR) register.

Alternative examples may use wider or narrower registers. Additionally, alternative examples may use more, less, or different register files and registers. The register architecture 1300 may, for example, be used in register file/memory 508, or physical register file(s) circuitry 1158.

### Instruction Set Architectures.

An instruction set architecture (ISA) may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down through the definition of instruction templates (or sub-formats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an example ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands. In addition, though the description below is made in the context of x86 ISA, it is within the knowledge of one skilled in the art to apply the teachings of the present disclosure in another ISA.

### Example Instruction Formats.

Examples of the instruction(s) described herein may be embodied in different formats. Additionally, example systems, architectures, and pipelines are detailed below. Examples of the instruction(s) may be executed on such systems, architectures, and pipelines, but are not limited to those detailed.

FIG. 14 illustrates examples of an instruction format. As illustrated, an instruction may include multiple components including, but not limited to, one or more fields for: one or more prefixes, an opcode, addressing information (e.g., register identifiers, memory addressing information, etc.), a displacement value, and/or an immediate value. Note that some instructions utilize some or all the fields of the format whereas others may only use the field for the opcode 1403. In some examples, the order illustrated is the order in which these fields are to be encoded, however, it should be appreciated that in other examples these fields may be encoded in a different order, combined, etc.

The prefix(es) f 1401, when used, modifies an instruction. In some examples, one or more prefixes are used to repeat string instructions (e.g., 0xF0, 0xF2, 0xF3, etc.), to provide section overrides (e.g., 0x2E, 0x36, 0x3E, 0x26, 0x64, 0x65, 0x2E, 0x3E, etc.), to perform bus lock operations, and/or to change operand (e.g., 0x66) and address sizes (e.g., 0x67). Certain instructions require a mandatory prefix (e.g., 0x66, 0xF2, 0xF3, etc.). Certain of these prefixes may be considered “legacy” prefixes. Other prefixes, one or more examples of which are detailed herein, indicate, and/or provide further capability, such as specifying particular registers, etc. The other prefixes typically follow the “legacy” prefixes.

The opcode field 1403 is used to at least partially define the operation to be performed upon a decoding of the instruction. In some examples, a primary opcode encoded in the opcode field 1403 is one, two, or three bytes in length. In other examples, a primary opcode can be a different length. An additional 3-bit opcode field is sometimes encoded in another field.

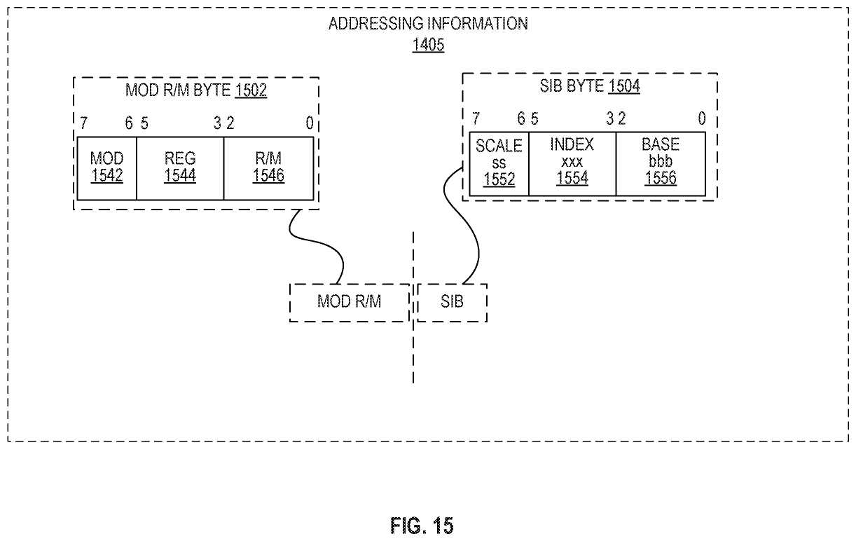

The addressing information field 1405 is used to address one or more operands of the instruction, such as a location in memory or one or more registers. FIG. 15 illustrates examples of the addressing information field 1405. In this illustration, an optional MOD R/M byte 1502 and an optional Scale, Index, Base (SIB) byte 1504 are shown. The MOD R/M byte 1502 and the SIB byte 1504 are used to encode up to two operands of an instruction, each of which is a direct register or effective memory address. Note that both of these fields are optional in that not all instructions include one or more of these fields. The MOD R/M byte 1502 includes a MOD field 1542, a register (reg) field 1544, and R/M field 1546.

The content of the MOD field 1542 distinguishes between memory access and non-memory access modes. In some examples, when the MOD field 1542 has a binary value of 11 (11b), a register-direct addressing mode is utilized, and otherwise a register-indirect addressing mode is used.

The register field 1544 may encode either the destination register operand or a source register operand or may encode an opcode extension and not be used to encode any instruction operand. The content of register field 1544, directly or through address generation, specifies the locations of a source or destination operand (either in a register or in memory). In some examples, the register field 1544 is supplemented with an additional bit from a prefix (e.g., prefix 1401) to allow for greater addressing.

The R/M field 1546 may be used to encode an instruction operand that references a memory address or may be used to encode either the destination register operand or a source register operand. Note the R/M field 1546 may be combined with the MOD field 1542 to dictate an addressing mode in some examples.

The SIB byte 1504 includes a scale field 1552, an index field 1554, and a base field 1556 to be used in the generation of an address. The scale field 1552 indicates a scaling factor. The index field 1554 specifies an index register to use. In some examples, the index field 1554 is supplemented with an additional bit from a prefix (e.g., prefix 1401) to allow for greater addressing. The base field 1556 specifies a base register to use. In some examples, the base field 1556 is supplemented with an additional bit from a prefix (e.g., prefix 1401) to allow for greater addressing. In practice, the content of the scale field 1552 allows for the scaling of the content of the index field 1554 for memory address generation (e.g., for address generation that uses 2^{scale}*index+base).

Some addressing forms utilize a displacement value to generate a memory address. For example, a memory address may be generated according to 2^{scale}*index+base+displacement, index*scale+displacement, r/m+displacement, instruction pointer (RIP/EIP)+displacement, register+displacement, etc. The displacement may be a 1-byte, 2-byte, 4-byte, etc. value. In some examples, the displacement field 1407 provides this value. Additionally, in some examples, a displacement factor usage is encoded in the MOD field of the addressing information field 1405 that indicates a compressed displacement scheme for which a displacement value is calculated and stored in the displacement field 1407.

In some examples, the immediate value field 1409 specifies an immediate value for the instruction. An immediate value may be encoded as a 1-byte value, a 2-byte value, a 4-byte value, etc.

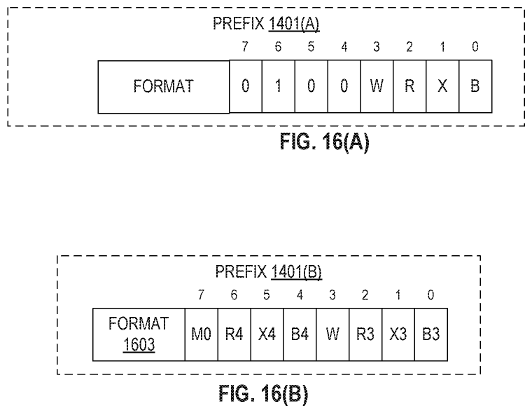

FIGS. 16(A)-(B) illustrates examples of a first prefix 1401(A). FIG. 16(A) illustrates first examples of the first prefix 1401(A). In some examples, the first prefix 1401(A) is an example of a REX prefix. Instructions that use this prefix may specify general purpose registers, 64-bit packed data registers (e.g., single instruction, multiple data (SIMD) registers or vector registers), and/or control registers and debug registers (e.g., CR8-CR15 and DR8-DR15).

Instructions using the first prefix 1401(A) may specify up to three registers using 3-bit fields depending on the format: 1) using the reg field 1544 and the R/M field 1546 of the MOD R/M byte 1502; 2) using the MOD R/M byte 1502 with the SIB byte 1504 including using the reg field 1544 and the base field 1556 and index field 1554; or 3) using the register field of an opcode.

In the first prefix 1401(A), bit positions of the payload byte 7:4 are set as 0100. Bit position 3 (W) can be used to determine the operand size but may not solely determine operand width. As such, when W=0, the operand size is determined by a code segment descriptor (CS.D) and when W=1, the operand size is 64-bit.

Note that the addition of another bit allows for 16 (2⁴) registers to be addressed, whereas the MOD R/M reg field 1544 and MOD R/M R/M field 1546 alone can each only address 8 registers.

In the first prefix 1401(A), bit position 2 (R) may be an extension of the MOD R/M reg field 1544 and may be used to modify the MOD R/M reg field 1544 when that field encodes a general-purpose register, a 64-bit packed data register (e.g., a SSE register), or a control or debug register. R is ignored when MOD R/M byte 1502 specifies other registers or defines an extended opcode.

Bit position 1 (X) may modify the SIB byte index field 1554.

Bit position 0 (B) may modify the base in the MOD R/M R/M field 1546 or the SIB byte base field 1556; or it may modify the opcode register field used for accessing general purpose registers (e.g., general purpose registers 1325).

FIG. 16(B) illustrates second examples of the first prefix 1401(A). In some examples, the prefix 1401(A) supports addressing 32 general purpose registers. In some examples, this prefix is called REX2.

In some examples, one or more of instructions for increment, decrement, negation, addition, subtraction, AND, OR, XOR, shift arithmetically left, shift logically left, shift arithmetically right, shift logically right, rotate left, rotate right, multiply, divide, population count, leading zero count, total zero count, etc. support flag suppression.

In some examples, one or more of instructions for increment, decrement, NOT, negation, addition, add with carry, integer subtraction with borrow, subtraction, AND, OR, XOR, shift arithmetically left, shift logically left, shift arithmetically right, shift logically right, rotate left, rotate right, multiply, divide, population count, leading zero count, total zero count, unsinged integer addition of two operands with carry flag, unsinged integer addition of two operands with overflow flag, conditional move, pop, push, etc. support REX2.

As shown, REX2 has a format field 1603 in a first byte and 8 bits in a second byte (e.g., a payload byte). In some examples, the format field 303 has a value of 0xD5. In some examples, 0xD5 encodes an ASCIII Adjust AX Before Division (AAD) instruction in a 32-bit mode. In those examples, in a 64-bit mode it is used as the first byte of the prefix of FIG. 16(B).

The payload byte includes several bits.

Bit position 0 (B3) may modify the base in the MOD R/M R/M field 1546 or the SIB byte base field 1556; or it may modify the opcode register field used for accessing general purpose registers (e.g., general purpose registers 1325).

Bit position 1 (X3) may modify the SIB byte index field 1554.

Bit position 2 (R3) may be used as an extension of the MOD R/M reg field 1544 and may be used to modify the MOD R/M reg field 1544 when that field encodes a general-purpose register, a 64-bit packed data register (e.g., an SSE register), or a control or debug register. R3 may be ignored when MOD R/M byte 1502 specifies other registers or defines an extended opcode.

Bit position 3 (W) can be used to determine an operand size, but may not solely determine operand width. As such, when W=0, the operand size is determined by a code segment descriptor (CS.D) and when W=1, the operand size is 64-bit.

Bit position 4 (B4) may further (along with B3) modify the base in the MOD R/M R/M field 1546 or the SIB byte base field 1556; or it may modify the opcode register field used for accessing general purpose registers (e.g., general purpose registers 1325).

Bit position 5 (X4) may further (along with X3) modify the SIB byte index field 1554.

Bit position 6 (R4) may further (along with R3) be used as an extension of the MOD R/M reg field 1544 and may be used to modify the MOD R/M reg field 1544 when that field encodes a general-purpose register, a 64-bit packed data register (e.g., an SSE register), or a control or debug register.

In some examples, bit position 7 (M0) indicates an opcode map (e.g., 0 or 1).

R3, R4, X3, X4, B3, and B4 allow for the addressing of 32 GPRs. That is an R, X or B register identifier is extended by the R3, X3, and B3 and R4, X4, and B4 bits in a REX2 prefix when and only when it encodes a GPR register. In some examples, the vector (or any other type of) registers are not encoded using those bits.

In some examples, REX2 must be the last prefix and the byte following it is interpreted as the main opcode byte in the opcode map indicated by M0. The 0x0F escape byte is neither needed nor allowed. In some examples, prefixes which may precede the REX2 prefix are LOCK (0xF0), REPE/REP/REPZ (0xF3), REPNE/REPNZ (0xF2), operand-size override (0x66), address-size override (0x67), and segment overrides.

In general, when any of the bits in REX2 R4, X4, B4, R3, X3, and B3 are not used they are ignored. For example, when there is no index register, X4 and X3 are both ignored. Similarly, when the R, X, or B register identifier encodes a vector register, the R4, X4, or B4 bit is ignored. There are, however, in some examples, one or two exceptions to this general rule: 1) an attempt to access a non-existent control register or debug register will trigger #UD and 2) instructions with opcodes 0x50-0x5F (including POP and PUSH) use R4 to encode a push-pop acceleration hint.

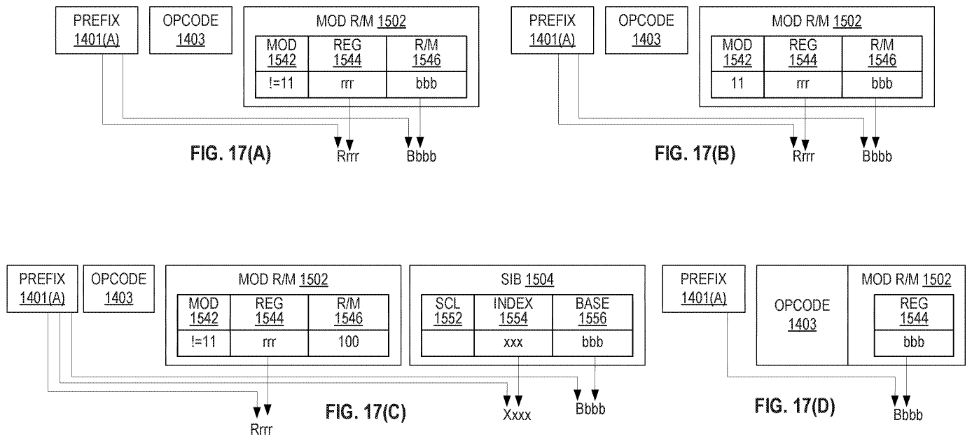

FIGS. 17(A)-(D) illustrate examples of how the R, X, and B fields of the first prefix 1401(A) are used. FIG. 17(A) illustrates R and B from the first prefix 1401(A) being used to extend the reg field 1544 and R/M field 1546 of the MOD R/M byte 1502 when the SIB byte 1504 is not used for memory addressing. FIG. 17(B) illustrates R and B from the first prefix 1401(A) being used to extend the reg field 1544 and R/M field 1546 of the MOD R/M byte 1502 when the SIB byte 1504 is not used (register-register addressing). FIG. 17(C) illustrates R, X, and B from the first prefix 1401(A) being used to extend the reg field 1544 of the MOD R/M byte 1502 and the index field 1554 and base field 1556 when the SIB byte 1504 being used for memory addressing. FIG. 17(D) illustrates B from the first prefix 1401(A) being used to extend the reg field 1544 of the MOD R/M byte 1502 when a register is encoded in the opcode 1403. The R4 and R3 values of FIG. 16(B) can be used to expand rrr, B4 and B3 can be used to expand bbb, and X4 and X3 can be used to expand xxx.

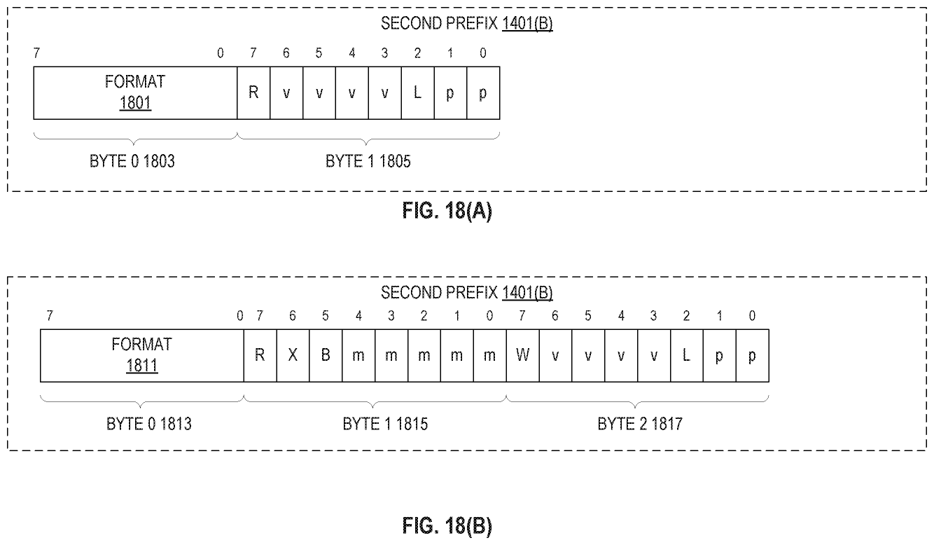

FIGS. 18(A)-(B) illustrate examples of a second prefix 1401(B). In some examples, the second prefix 1401(B) is an example of a VEX prefix. The second prefix 1401(B) encoding allows instructions to have more than two operands, and allows SIMD vector registers (e.g., vector/SIMD registers 1310) to be longer than 64-bits (e.g., 128-bit and 256-bit). The use of the second prefix 1401(B) provides for three-operand (or more) syntax. For example, previous two-operand instructions performed operations such as A=A+B, which overwrites a source operand. The use of the second prefix 1401(B) enables operands to perform nondestructive operations such as A=B+C.

In some examples, the second prefix 1401(B) comes in two forms—a two-byte form and a three-byte form. The two-byte second prefix 1401(B) is used mainly for 128-bit, scalar, and some 256-bit instructions; while the three-byte second prefix 1401(B) provides a compact replacement of the first prefix 1401(A) and 3-byte opcode instructions.

FIG. 18(A) illustrates examples of a two-byte form of the second prefix 1401(B). In some examples, a format field 1801 (byte 0 1803) contains the value C5H. In some examples, byte 1 1805 includes an “R” value in bit[7]. This value is the complement of the “R” value of the first prefix 1401(A). Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3] shown as vvv may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the MOD R/M R/M field 1546 to encode the instruction operand that references a memory address or encode either the destination register operand or a source register operand.

Instructions that use this prefix may use the MOD R/M reg field 1544 to encode either the destination register operand or a source register operand, or to be treated as an opcode extension and not used to encode any instruction operand.

For instruction syntax that support four operands, ww, the MOD R/M R/M field 1546 and the MOD R/M reg field 1544 encode three of the four operands. Bits[7:4] of the immediate value field 1409 are then used to encode the third source register operand.

FIG. 18(B) illustrates examples of a three-byte form of the second prefix 1401(B). In some examples, a format field 1811 (byte 0 1813) contains the value C4H. Byte 1 1815 includes in bits[7:5] “R,” “X,” and “B” which are the complements of the same values of the first prefix 1401(A). Bits[4:0] of byte 1 1815 (shown as mmmmm) include content to encode, as need, one or more implied leading opcode bytes. For example, 00001 implies a 0FH leading opcode, 00010 implies a 0F38H leading opcode, 00011 implies a 0F3AH leading opcode, etc.

Bit[7] of byte 2 1817 is used similar to W of the first prefix 1401(A) including helping to determine promotable operand sizes. Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3], shown as vvvv, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the MOD R/M R/M field 1546 to encode the instruction operand that references a memory address or encode either the destination register operand or a source register operand.

Instructions that use this prefix may use the MOD R/M reg field 1544 to encode either the destination register operand or a source register operand, or to be treated as an opcode extension and not used to encode any instruction operand.

For instruction syntax that support four operands, ww, the MOD R/M R/M field 1546, and the MOD R/M reg field 1544 encode three of the four operands. Bits[7:4] of the immediate value field 1409 are then used to encode the third source register operand.

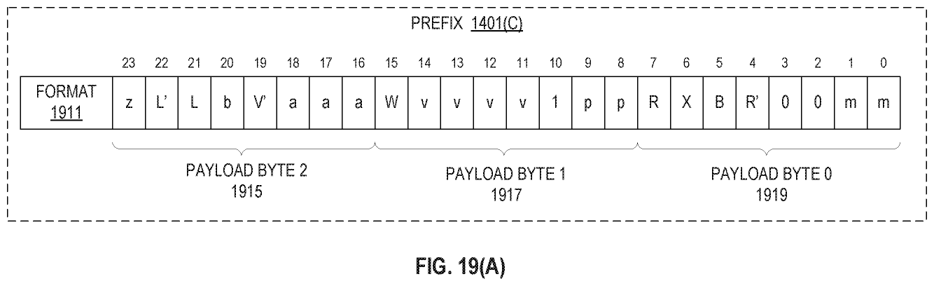

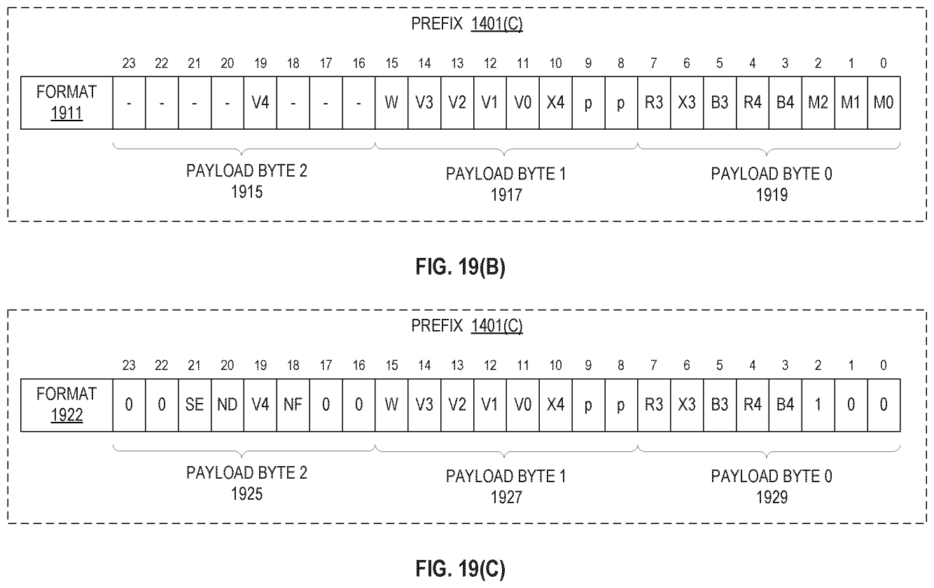

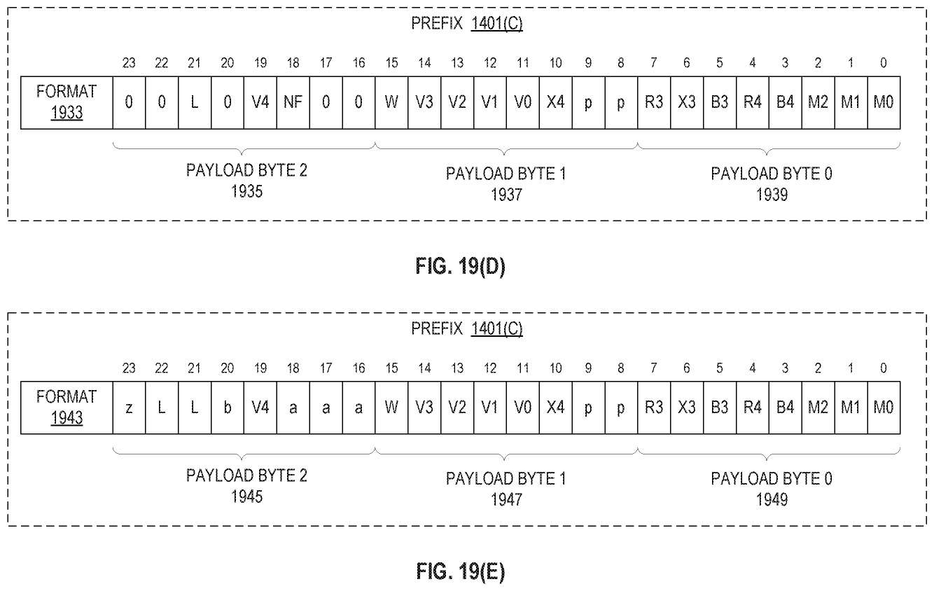

FIGS. 19(A)-(E) illustrates examples of a third prefix 1401(C). FIG. 19(A) illustrates first examples of the third prefix. In some examples, the third prefix 1401(C) is an example of an EVEX prefix. The third prefix 1401(C) is a four-byte prefix.

The third prefix 1401(C) can encode 32 vector registers (e.g., 128-bit, 256-bit, and 512-bit registers) in 64-bit mode. In some examples, instructions that utilize a writemask/opmask (see discussion of registers in a previous figure, such as FIG. 13) or predication utilize this prefix. Opmask register allow for conditional processing or selection control. Opmask instructions, whose source/destination operands are opmask registers and treat the content of an opmask register as a single value, are encoded using the second prefix 1401(B).

The third prefix 1401(C) may encode functionality that is specific to instruction classes (e.g., a packed instruction with “load+op” semantic can support embedded broadcast functionality, a floating-point instruction with rounding semantic can support static rounding functionality, a floating-point instruction with non-rounding arithmetic semantic can support “suppress all exceptions” functionality, etc.).

The first byte of the third prefix 1401(C) is a format field 1911 that has a value, in some examples, of 62H. Subsequent bytes are referred to as payload bytes 1915-1919 and collectively form a 24-bit value of P[23:0] providing specific capability in the form of one or more fields (detailed herein).

In some examples, P[1:0] of payload byte 1919 are identical to the low two mm bits. P[3:2] are reserved in some examples. Bit P[4] (R′) allows access to the high 16 vector register set when combined with P[7] and the MOD R/M reg field 1544. P[6] can also provide access to a high 16 vector register when SIB-type addressing is not needed. P[7:5] consist of R, X, and B which are operand specifier modifier bits for vector register, general purpose register, memory addressing and allow access to the next set of 8 registers beyond the low 8 registers when combined with the MOD R/M register field 1544 and MOD R/M R/M field 1546. P[9:8] provide opcode extensionality equivalent to some legacy prefixes (e.g., 00=no prefix, 01=66H, 10=F3H, and 11=F2H). P[10] in some examples is a fixed value of 1. P[14:11], shown as vwwv, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

P[15] is similar to W of the first prefix 1401(A) and second prefix 1401(B) and may serve as an opcode extension bit or operand size promotion.

P[18:16] specify the index of a register in the opmask (writemask) registers (e.g., writemask/predicate registers 1315). In some examples, the specific value aaa=000 has a special behavior implying no opmask is used for the particular instruction (this may be implemented in a variety of ways including the use of an opmask hardwired to all ones or hardware that bypasses the masking hardware). When merging, vector masks allow any set of elements in the destination to be protected from updates during the execution of any operation (specified by the base operation and the augmentation operation); in other some examples, preserving the old value of each element of the destination where the corresponding mask bit has a 0. In contrast, when zeroing vector masks allow any set of elements in the destination to be zeroed during the execution of any operation (specified by the base operation and the augmentation operation); in some examples, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the opmask field allows for partial vector operations, including loads, stores, arithmetic, logical, etc. While examples are described in which the opmask field's content selects one of a number of opmask registers that contains the opmask to be used (and thus the opmask field's content indirectly identifies that masking to be performed), alternative examples instead or additional allow the mask write field's content to directly specify the masking to be performed.

P[19] can be combined with P[14:11] to encode a second source vector register in a non-destructive source syntax which can access an upper 16 vector registers using P[19]. P[20] encodes multiple functionalities, which differ across different classes of instructions and can affect the meaning of the vector length/rounding control specifier field (P[22:21]). P[23] indicates support for merging-writemasking (e.g., when set to 0) or support for zeroing and merging-writemasking (e.g., when set to 1).

Example examples of encoding of registers in instructions using the third prefix 1401(C) are detailed in the following tables.

TABLE 1
32-Register Support in 64-bit Mode

| | | | | REG. | |
|---|---|---|---|---|---|
| | 4 | 3 | [2:0] | TYPE | COMMON USAGES |
| REG | R′ | R | MOD R/M | GPR, | Destination or Source |
| | | | reg | Vector | |
| VVVV | V′ | vvvv | | GPR, | 2nd Source or Destination |
| | | | | Vector | |
| RM | X | B | MOD R/M | GPR, | 1st Source or Destination |
| | | | R/M | Vector | |
| BASE | 0 | B | MOD R/M | GPR | Memory addressing |
| | | | R/M | | |
| INDEX | 0 | X | SIB.index | GPR | Memory addressing |
| VIDX | V′ | X | SIB.index | Vector | VSIB memory addressing |

TABLE 2
Encoding Register Specifiers in 32-bit Mode

| | [2:0] | REG. TYPE | COMMON USAGES |
|---|---|---|---|
| REG | MOD R/M reg | GPR, Vector | Destination or Source |
| VVVV | vvvv | GPR, Vector | 2^{nd} Source or Destination |
| RM | MOD R/M R/M | GPR, Vector | 1^{st} Source or Destination |
| BASE | MOD R/M R/M | GPR | Memory addressing |
| INDEX | SIB.index | GPR | Memory addressing |
| VIDX | SIB.index | Vector | VSIB memory addressing |

TABLE 3
Opmask Register Specifier Encoding

| | [2:0] | REG. TYPE | COMMON USAGES |
|---|---|---|---|
| REG | MOD R/M Reg | k0-k7 | Source |
| VVVV | vvvv | k0-k7 | 2^{nd} Source |
| RM | MOD R/M R/M | k0-k7 | 1^{st} Source |
| {k1} | aaa | k0-k7 | Opmask |

FIG. 19(B) illustrates second examples of the third prefix. In some examples, the prefix 15K01(B) is an example of an EVEX2 prefix. The EVEX2 prefix 1401(C) is a four-byte prefix.

In some examples, one or more of instructions for increment, decrement, NOT, negation, addition, add with carry, integer subtraction with borrow, subtraction, AND, OR, XOR, shift arithmetically left, shift logically left, shift arithmetically right, shift logically right, rotate left, rotate right, multiply, divide, population count, pop, push, leading zero count, total zero count, unsinged integer addition of two operands with carry flag, unsinged integer addition of two operands with overflow flag, conditional move, etc. support EVEX2.

For these instructions there it should be noted that NDD may or may not be used depending on the settings of the prefix of those instructions.

The extended EVEX prefix is an extension of a 4-byte EVEX prefix and is used to provide APX features for legacy instructions which cannot be provided by the REX2 prefix (in particular, the new data destination) and APX extensions of VEX and EVEX instructions.

Most bits in the third payload byte (except for the V4 bit) are left unspecified because the payload bit assignment depends on whether the EVEX prefix is used to provide APX extension to a legacy, VEX, or EVEX instruction, the details of which will be given in the subsections below. The byte following the extended EVEX prefix is always interpreted as the main opcode byte. Escape sequences 0x0F, 0x0F38 and 0x0F3A are neither needed nor allowed.

The EVEX2 prefix 1401(B) can encode 32 vector registers (e.g., 128-bit, 256-bit, and 512-bit registers) in 64-bit mode and/or 32 general purpose registers.

The EVEX2 prefix 1401(B) may encode functionality that is specific to instruction classes (e.g., a packed instruction with “load+op” semantic can support embedded broadcast functionality, a floating-point instruction with rounding semantic can support static rounding functionality, a floating-point instruction with non-rounding arithmetic semantic can support “suppress all exceptions” functionality, etc.).

The first byte of the EVEX2 prefix 1401(B) is a format field 1411 that has a value, in some examples, of 0x62. Subsequent bytes are referred to as payload bytes 1415-1419 and collectively form a 24-bit value of P[23:0] providing specific capability in the form of one or more fields (detailed herein).
Bits 0:2 (M0, M1, and M2) of a first payload byte (payload byte 0) 1917 are used to provide an opcode map identification. Note that this is limited to 8 maps.
Bit 3 (B4) provides the fifth bit and most significant bit for the B register identifier.
Bit 4 (R4) provides the fifth bit and most significant bit for the R register identifier.
Bit 5 (B3), bit 6 (X3), and bit 7 (R3) provide the fourth bit for the B, X, and R register identifiers respectively when combined with a MOD R/M register field (R register), a MOD R/M R/M field (B register), and/or a SIB.INDEX field (X register).
Bits 9:8 provide opcode extensionality equivalent to some legacy prefixes (e.g., 00=no prefix, 01=66H, 10=F3H, and 11=F2H).
Bit 10 (X4) provides the fifth bit and most significant bit for the X register identifier.
Bits 14:11, shown as V3V2V1V0 may be used to: 1) encode the first source register operand, specified in inverted (1s complement) form and valid for instructions with 2 or more source operands; 2) encode a new data destination register operand, specified in 1s complement form for certain vector shifts; or 3) not encode any operand, the field is reserved and should contain a certain value, such as 1111b.
Bit 15 (W) may serve as an opcode extension bit or operand size promotion.
Bit 19 can be combined with bits 14:11 to encode a register in a new data destination.

In some examples, R3, R4, B3, X3, X4, V3, V2, V1, V0 are inverted. In some examples, B4 and X5 are repurposed reserved bits of an existing prefix that are used to provide the fifth and most significant bits of the B and X register identifiers. Their polarities are chosen so that the current fixed values at those two locations encode logical 0 after the repurposing. (In other words, the current fixed value at B4 is 0 and that at X4 is 1.)

Example examples of source and/or destination encoding in instructions using the EVEX2 prefix 1401(C) are detailed in the following table.

| | | | | REG. | |
|---|---|---|---|---|---|
| | 4 | 3 | [2:0] | TYPE | COMMON USAGES |
| R | R4 | R3 | MOD R/M | GPR | Destination or Source |
| register | | | reg | | |
| B | B4 | B3 | MOD R/M | GPR | Destination or Source |
| register | | | reg | | |
| V | V4 | V3V2V1V0 | | GPR | 2nd Source or Destination |
| register | | | | | |
| RM | B4 | B3 | MOD R/M | GPR | 1st Source or Destination |
| | | | R/M | | |
| BASE | B4 | B3 | MOD R/M | GPR | Memory addressing |
| | | | R/M | | |
| INDEX | X4 | X3 | SIB.index | GPR | Memory addressing |

FIG. 19(C) illustrates third examples of the third prefix. In some examples, the prefix 1401(C) is an example of an EVEX2 prefix. The EVEX2 prefix 1401(C) is a four-byte prefix.

The EVEX2 prefix 1401(C) can encode at least 32 vector registers (e.g., 128-bit, 256-bit, and 512-bit registers) in 64-bit mode and/or up to 64 general purpose registers.

The EVEX2 prefix 1401(C) may encode functionality that is specific to instruction classes (e.g., a packed instruction with “load+op” semantic can support embedded broadcast functionality, a floating-point instruction with rounding semantic can support static rounding functionality, a floating-point instruction with non-rounding arithmetic semantic can support “suppress all exceptions” functionality, etc.).

The first byte of the EVEX2 prefix 1401(C) is a format field 1922 that has a value, in one example, of 0x62. Subsequent bytes are referred to as payload bytes 555-1929 and collectively form a 24-bit value of P[23:0] providing specific capability in the form of one or more fields (detailed herein).
Bits 0:1 are set to zero and bit 2 is set to 1.
Bit 3 (B4) provides the fifth bit and most significant bit for the B register identifier.
Bit 4 (R4) provides the fifth bit and most significant bit for the R register identifier.
Bit 5 (B3), bit 6 (X3), and bit 7 (R3) provide the fourth bit for the B, X, and R register identifiers respectively when combined with a MOD R/M register field (R register), a MOD R/M R/M field (B register), and/or a SIB.INDEX field (X register).
Bits 9:8 provide opcode extensionality equivalent to some legacy prefixes (e.g., 00=no prefix, 01=66H, 10=F3H, and 11=F2H).
Bit 10 (X4) provides the fifth bit and most significant bit for the X register identifier.
Bits 14:11, shown as V3V2V1V0 may be used to: 1) encode the first source register operand, specified in inverted (1s complement) form and valid for instructions with 2 or more source operands; 2) encode a new data destination register operand, specified in 1s complement form for certain vector shifts; or 3) not encode any operand, the field is reserved and should contain a certain value, such as 1111b.
Bit 15 (W) may serve as an opcode extension bit or operand size promotion.
Bits 16:17 are zero.
Bit 18 is used to indicate a flags update suppression in most examples. When set to 1, the carry, sign, zero, adjust, overflow, and parity bits are not updated. In some examples, instructions for increment, decrement, negation, addition, subtraction, AND, OR, shift arithmetically left, shift logically left, shift arithmetically right, shift logically right, rotate left, rotate right, multiply, divide, population count, leading zero count, total zero count, etc. support flag suppression.
Bit 19 can be combined with bits 14:11 to encode a register in a new data destination.
Bit 20 indicates a NDD in some examples. In some examples, if EVEX2.ND=0, there is no NDD and EVEX2. [V4,V3,V2,V1,V0] must be all zero. In some examples, if EVEX2.ND=1, there is an NDD whose register ID is encoded by EVEX2. [V4,V3,V2,V1,V0]. Although some instructions do not support NDD, the EVEX2.ND bit may be used to control whether its destination register has its upper bits (namely, bits[63: operand size]) zeroed when operand size is 8-bit or 16-bit. That is, if EVEX2.ND=1, the upper bits are always zeroed; otherwise, they keep the old values when operand size is 8-bit or 16-bit. For these instructions, EVEX2. [V4,V3,V2,V1,V0] is all zero.

Bit 21 is used in some examples to indicate exceptions are to be suppressed.

In some examples, R3, R4, B3, X3, X4, V3, V2, V1, V0 are inverted. In some examples, B4 and X5 are repurposed reserved bits of an existing prefix that are used to provide the fifth and most significant bits of the B and X register identifiers. Their polarities are chosen so that the current fixed values at those two locations encode logical 0 after the repurposing. (In other words, the current fixed value at B4 is 0 and that at X4 is 1.)

Example examples of source and/or destination encoding in instructions using the EVEX2 prefix 1401(C) are detailed in the following table.

| | | | | REG. | |
|---|---|---|---|---|---|
| | 4 | 3 | [2:0] | TYPE | COMMON USAGES |
| R | R4 | R3 | MOD R/M | GPR | Destination or Source |
| register | | | reg | | |
| B | B4 | B3 | MOD R/M | GPR | Destination or Source |
| register | | | reg | | |
| V | V4 | V3V2V1V0 | | GPR | 2nd Source or Destination |
| register | | | | | |
| RM | B4 | B3 | MOD R/M | GPR | 1st Source or Destination |
| | | | R/M | | |
| BASE | B4 | B3 | MOD R/M | GPR | Memory addressing |
| | | | R/M | | |
| INDEX | X4 | X3 | SIB.index | GPR | Memory addressing |

FIG. 19(D) illustrates fourth examples of the third prefix. In some examples, the prefix 1401(C) is an example of an EVEX2 prefix. The EVEX2 prefix 1401(C) is a four-byte prefix.

The extended EVEX prefix is an extension of the current 4-byte EVEX prefix and is used to provide APX features for legacy instructions which cannot be provided by the REX2 prefix (in particular, the new data destination) and APX extensions of VEX and EVEX instructions. Most bits in the third payload byte (except for the V4 bit) are left unspecified because the payload bit assignment depends on whether the EVEX prefix is used to provide APX extension to a legacy, VEX, or EVEX instruction, the details of which will be given in the subsections below. The byte following the extended EVEX prefix is always interpreted as the main opcode byte. Escape sequences 0x0F, 0x0F38 and 0x0F3A are neither needed nor allowed.

The EVEX2 prefix 1401(C) can encode 32 vector registers (e.g., 128-bit, 256-bit, and 512-bit registers) in 64-bit mode and/or 32 general purpose registers.

The EVEX2 prefix 1401(C) may encode functionality that is specific to instruction classes (e.g., a packed instruction with “load+op” semantic can support embedded broadcast functionality, a floating-point instruction with rounding semantic can support static rounding functionality, a floating-point instruction with non-rounding arithmetic semantic can support “suppress all exceptions” functionality, etc.).

The first byte of the EVEX2 prefix 1401(C) is a format field 1933 that has a value, in some examples, of 0x62. Subsequent bytes are referred to as payload bytes 1935-1939 and collectively form a 24-bit value of P[23:0] providing specific capability in the form of one or more fields (detailed herein).
Bits 0:2 (M0, M1, and M2) of a first payload byte (payload byte 0) 1939 are used to provide an opcode map identification. Note that this is limited to 8 maps.
Bit 3 (B4) provides the fifth bit and most significant bit for the B register identifier.
Bit 4 (R4) provides the fifth bit and most significant bit for the R register identifier.
Bit 5 (B3), bit 6 (X3), and bit 7 (R3) provide the fourth bit for the B, X, and R register identifiers respectively when combined with a MOD R/M register field (R register), a MOD R/M R/M field (B register), and/or a SIB.INDEX field (X register).
Bits 9:8 provide opcode extensionality equivalent to some legacy prefixes (e.g., 00=no prefix, 01=66H, 10=F3H, and 11=F2H).
Bit 10 (X4) provides the fifth bit and most significant bit for the X register identifier.
Bits 14:11, shown as V3V2V1V0 may be used to: 1) encode the first source register operand, specified in inverted (1s complement) form and valid for instructions with 2 or more source operands; 2) encode a new data destination register operand, specified in 1s complement form for certain vector shifts; or 3) not encode any operand, the field is reserved and should contain a certain value, such as 1111b.
Bit 15 (W) may serve as an opcode extension bit or operand size promotion.
Bits 16:17 are zero.
Bit 18 is used to indicate a flags update suppression in most examples. When set to 1, the carry, sign, zero, adjust, overflow, and parity bits are not updated.
Bit 19 can be combined with bits 14:11 to encode a register in a new data destination.
Bits 20, 22, and 23 are zero.
Bit 21 is a length specifier field

In some examples, R3, R4, B3, X3, X4, V3, V2, V1, V0 are inverted. In some examples, B4 and X5 are repurposed reserved bits of an existing prefix that are used to provide the fifth and most significant bits of the B and X register identifiers. Their polarities are chosen so that the current fixed values at those two locations encode logical 0 after the repurposing. (In other words, the current fixed value at B4 is 0 and that at X4 is 1.)

Example examples of source and/or destination encoding in instructions using the EVEX2 prefix 1401(C) are detailed in the following table.

| | | | | REG. | |
|---|---|---|---|---|---|
| | 4 | 3 | [2:0] | TYPE | COMMON USAGES |
| R | R4 | R3 | MOD R/M | GPR | Destination or Source |
| register | | | reg | | |
| B | B4 | B3 | MOD R/M | GPR | Destination or Source |
| register | | | reg | | |
| V | V4 | V3V2V1V0 | | GPR | 2nd Source or Destination |
| register | | | | | |
| RM | B4 | B3 | MOD R/M | GPR | 1st Source or Destination |
| | | | R/M | | |
| BASE | B4 | B3 | MOD R/M | GPR | Memory addressing |
| | | | R/M | | |
| INDEX | X4 | X3 | SIB.index | GPR | Memory addressing |

FIG. 19(E) illustrates fifth examples of the third prefix. In some examples, the prefix 1401(C) is an example of an EVEX2 prefix. The EVEX2 prefix 1401(C) is a four-byte prefix.

The EVEX2 prefix 1401(C) can encode at least 32 vector registers (e.g., 128-bit, 256-bit, and 512-bit registers) in 64-bit mode and/or up to 64 general purpose registers. I

The EVEX2 prefix 1401(C) may encode functionality that is specific to instruction classes (e.g., a packed instruction with “load+op” semantic can support embedded broadcast functionality, a floating-point instruction with rounding semantic can support static rounding functionality, a floating-point instruction with non-rounding arithmetic semantic can support “suppress all exceptions” functionality, etc.).

The first byte of the EVEX2 prefix 1401(C) is a format field 1943 that has a value, in one example, of 0x62. Subsequent bytes are referred to as payload bytes 1945-1949 and collectively form a 24-bit value of P[23:0] providing specific capability in the form of one or more fields (detailed herein).
Bits 0:2 (M0, M1, and M2) of a first payload byte (payload byte 0) 1939 are used to provide an opcode map identification. Note that this is limited to 8 maps.
Bit 3 (B4) provides the fifth bit and most significant bit for the B register identifier.
Bit 4 (R4) provides the fifth bit and most significant bit for the R register identifier.
Bit 5 (B3), bit 6 (X3), and bit 7 (R3) provide the fourth bit for the B, X, and R register identifiers respectively when combined with a MOD R/M register field (R register), a MOD R/M R/M field (B register), and/or a SIB.INDEX field (X register).
Bits 9:8 provide opcode extensionality equivalent to some legacy prefixes (e.g., 00=no prefix, 01=66H, 10=F3H, and 11=F2H).
Bit 10 (X4) provides the fifth bit and most significant bit for the X register identifier.
Bits 14:11, shown as V3V2V1V0 may be used to: 1) encode the first source register operand, specified in inverted (1s complement) form and valid for instructions with 2 or more source operands; 2) encode a new data destination register operand, specified in 1s complement form for certain vector shifts; or 3) not encode any operand, the field is reserved and should contain a certain value, such as 1111b.
Bit 15 (W) may serve as an opcode extension bit or operand size promotion.
Bits 16:18 specify the index of a register in the opmask (writemask) registers (e.g., writemask/predicate registers 2615). In one example, the specific value aaa=000 has a special behavior implying no opmask is used for the particular instruction (this may be implemented in a variety of ways including the use of an opmask hardwired to all ones or hardware that bypasses the masking hardware). When merging, vector masks allow any set of elements in the destination to be protected from updates during the execution of any operation (specified by the base operation and the augmentation operation); in other one example, preserving the old value of each element of the destination where the corresponding mask bit has a 0. In contrast, when zeroing vector masks allow any set of elements in the destination to be zeroed during the execution of any operation (specified by the base operation and the augmentation operation); in one example, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the opmask field allows for partial vector operations, including loads, stores, arithmetic, logical, etc. While examples are described in which the opmask field's content selects one of a number of opmask registers that contains the opmask to be used (and thus the opmask field's content indirectly identifies that masking to be performed), alternative examples instead or additional allow the mask write field's content to directly specify the masking to be performed.
Bit 19 can be combined with bits 14:11 to encode a register in a new data destination.
Bit 20 encodes multiple functionalities, which differ across different classes of instructions and can affect the meaning of the vector length/rounding control specifier field bits 21:22]).
Bit 23 indicates support for merging-writemasking (e.g., when set to 0) or support for zeroing and merging-writemasking (e.g., when set to 1).

In some examples, R3, R4, B3, X3, X4, V3, V2, V1, V0 are inverted. In some examples, B4 and X5 are repurposed reserved bits of an existing prefix that are used to provide the fifth and most significant bits of the B and X register identifiers. Their polarities are chosen so that the current fixed values at those two locations encode logical 0 after the repurposing. (In other words, the current fixed value at B4 is 0 and that at X4 is 1.)

Example examples of source and/or destination encoding in instructions using the EVEX2 prefix 1401(C) are detailed in the following table.

| | | | | REG. | |
|---|---|---|---|---|---|
| | 4 | 3 | [2:0] | TYPE | COMMON USAGES |
| R | R4 | R3 | MOD R/M | GPR | Destination or Source |
| register | | | reg | | |
| B | B4 | B3 | MOD R/M | GPR | Destination or Source |
| register | | | reg | | |
| V | V4 | V3V2V1V0 | | GPR | 2nd Source or Destination |
| register | | | | | |
| RM | B4 | B3 | MOD R/M | GPR | 1st Source or Destination |
| | | | R/M | | |
| BASE | B4 | B3 | MOD R/M | GPR | Memory addressing |
| | | | R/M | | |
| INDEX | X4 | X3 | SIB.index | GPR | Memory addressing |

The table below illustrates the new prefixes and how they differ from at least one legacy format. Note that OP is an operation to be performed.

| | APX REX2 (No-NDD) | APX EVEX2 (NDD) |
|---|---|---|
| Legacy Format | Prefix | Prefix |
| OP R/M, Reg | OP R/M, Reg | V = OP R/M, Reg |
| OP Reg, R/M | OP Reg, R/M | V = OP Reg, R/M |
| OP R/M, Imm | OP R/M, Imm | V = OP R/M, Imm |
| OP R/M | OP R/M | V = OP R/M |

Program code may be applied to input information to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), a field programmable gate array (FPGA), a microprocessor, or any combination thereof.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors and/or system features described herein. Such examples may also be referred to as program products.

Emulation (including binary translation, code morphing, etc.).

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

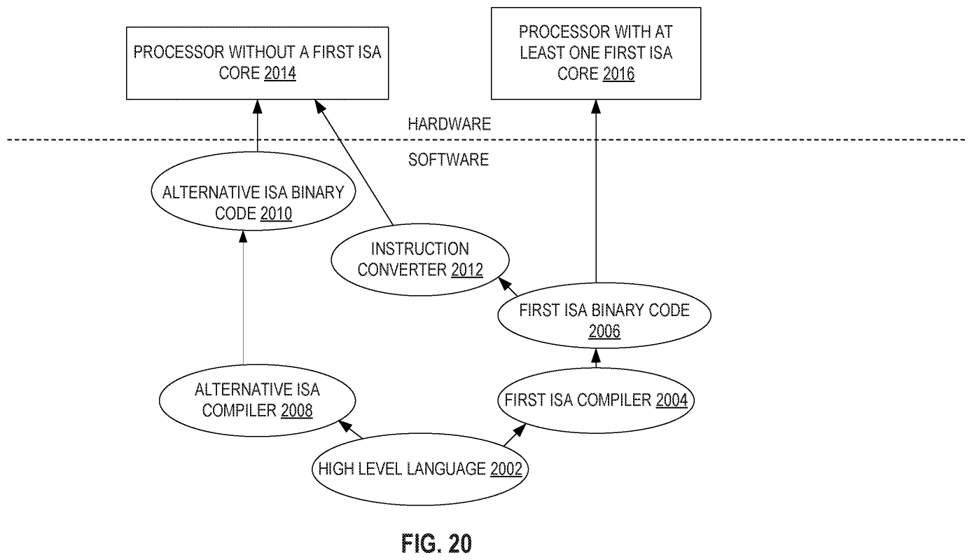

FIG. 20 is a block diagram illustrating the use of a software instruction converter to convert binary instructions in a source ISA to binary instructions in a target ISA according to examples. In the illustrated example, the instruction converter is a software instruction converter, although alternatively the instruction converter may be implemented in software, firmware, hardware, or various combinations thereof. FIG. 20 shows a program in a high-level language 2002 may be compiled using a first ISA compiler 2004 to generate first ISA binary code 2006 that may be natively executed by a processor with at least one first ISA core 2016. The processor with at least one first ISA core 2016 represents any processor that can perform substantially the same functions as an Intel® processor with at least one first ISA core by compatibly executing or otherwise processing (1) a substantial portion of the first ISA or (2) object code versions of applications or other software targeted to run on an Intel processor with at least one first ISA core, in order to achieve substantially the same result as a processor with at least one first ISA core. The first ISA compiler 2004 represents a compiler that is operable to generate first ISA binary code 2006 (e.g., object code) that can, with or without additional linkage processing, be executed on the processor with at least one first ISA core 2016. Similarly, FIG. 20 shows the program in the high-level language 2002 may be compiled using an alternative ISA compiler 2008 to generate alternative ISA binary code 2010 that may be natively executed by a processor without a first ISA core 2014. The instruction converter 2012 is used to convert the first ISA binary code 2006 into code that may be natively executed by the processor without a first ISA core 2014. This converted code is not necessarily to be the same as the alternative ISA binary code 2010; however, the converted code will accomplish the general operation and be made up of instructions from the alternative ISA. Thus, the instruction converter 2012 represents software, firmware, hardware, or a combination thereof that, through emulation, simulation or any other process, allows a processor or other electronic device that does not have a first ISA processor or core to execute the first ISA binary code 2006.

### IP Core Implementations

One or more aspects of at least some examples may be implemented by representative code stored on a machine-readable medium which represents and/or defines logic within an integrated circuit such as a processor. For example, the machine-readable medium may include instructions which represent various logic within the processor. When read by a machine, the instructions may cause the machine to fabricate the logic to perform the techniques described herein. Such representations, known as “IP cores,” are reusable units of logic for an integrated circuit that may be stored on a tangible, machine-readable medium as a hardware model that describes the structure of the integrated circuit. The hardware model may be supplied to various customers or manufacturing facilities, which load the hardware model on fabrication machines that manufacture the integrated circuit. The integrated circuit may be fabricated such that the circuit performs operations described in association with any of the examples described herein.

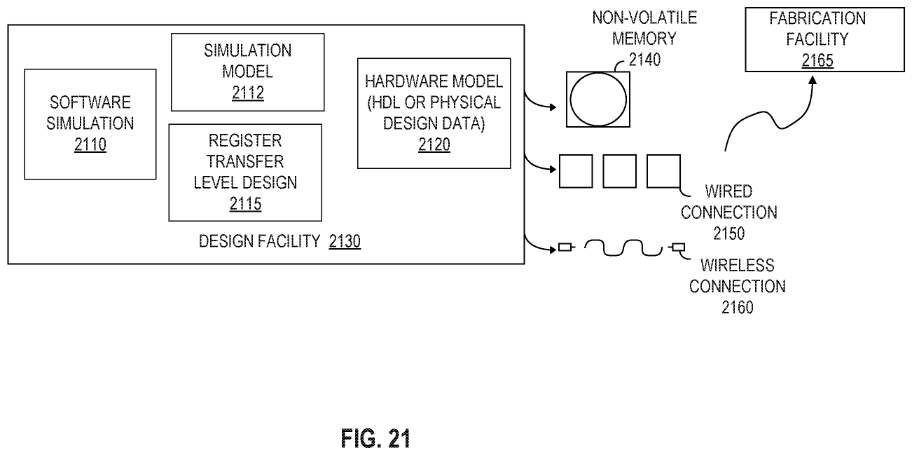

FIG. 21 is a block diagram illustrating an IP core development system 2100 that may be used to manufacture an integrated circuit to perform operations according to some examples. The IP core development system 2100 may be used to generate modular, reusable designs that can be incorporated into a larger design or used to construct an entire integrated circuit (e.g., an SOC integrated circuit). A design facility 2130 can generate a software simulation 2110 of an IP core design in a high-level programming language (e.g., C/C++). The software simulation 2110 can be used to design, test, and verify the behavior of the IP core using a simulation model 2112. The simulation model 2112 may include functional, behavioral, and/or timing simulations. A register transfer level (RTL) design 2115 can then be created or synthesized from the simulation model 2112. The RTL design 2115 is an abstraction of the behavior of the integrated circuit that models the flow of digital signals between hardware registers, including the associated logic performed using the modeled digital signals. In addition to an RTL design 2115, lower-level designs at the logic level or transistor level may also be created, designed, or synthesized. Thus, the particular details of the initial design and simulation may vary.

The RTL design 2115 or equivalent may be further synthesized by the design facility into a hardware model 2120, which may be in a hardware description language (HDL), or some other representation of physical design data. The HDL may be further simulated or tested to verify the IP core design. The IP core design can be stored for delivery to a fabrication facility 2165 using non-volatile memory 2140 (e.g., hard disk, flash memory, or any non-volatile storage medium). Alternatively, the IP core design may be transmitted (e.g., via the Internet) over a wired connection 2150 or wireless connection 2160. The fabrication facility 2165 may then fabricate an integrated circuit that is based at least in part on the IP core design. The fabricated integrated circuit can be configured to perform operations in accordance with at least some examples described herein.

References to “some examples,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e. A and B, A and C, B and C, and A, B and C).

Examples may include, but are not limited to:
1. An apparatus comprising: decoder circuitry to decode an instance of a single instruction, the instance of the single instruction has at least one field for an opcode and at least one field to identify a location in memory that is to store a descriptor; and execution circuitry to execute the decoded instruction according to the opcode to at least prefetch the descriptor, interpret fields of the descriptor, prefetch packed blocks representing matrix data from memory, decode and/or decompress the packed blocks, generate one or more index/value tokens or dense matrices based on sparsity metadata, and buffer the one or more index/value tokens or dense matrices based on sparsity metadata into a destination.
2. The apparatus of example 1, wherein the one or more index/value tokens or dense matrices are buffered in a location accessible by matrix hardware.
3. The apparatus of example 2, wherein the matrix hardware is one of a neural processing unit (NPU), a graphics processing unit (GPU), or a matrix processing unit (MPU).
4. The apparatus of any of examples 1-3, wherein the descriptor is to include at least one of a base address of packed matrix blocks, an indication of a size of each packed matrix block, a data type, an indication of a sparse matrix format, an indication of the destination, an indication of a prefetch length, an indication of a transformation to perform, and/or an indication of a location for a codebook.
5. The apparatus of example 4, wherein the packed matrix blocks are weights for a machine learning model.
6. The apparatus of example 4, wherein the data type is at least one of a two-bit integer (INT2), a four-bit integer (INT4), an eight-bit integer (INT8), a sixteen-bit integer (INT16), a four-bit floating point (FP4), an 8-bit-bit floating point (FP8), or a sixteen-bit floating point (FP16).
7. The apparatus of example 6, wherein the execution circuitry is to generate dequantized index/value tokens or dense matrices based on sparsity metadata.
8. The apparatus of any of examples 1-7, wherein the execution circuitry is to decode using a codebook.
9. The apparatus of any of examples 1-8, wherein the memory is one of random dynamic access memory (DRAM), high-bandwidth memory (HBM), or cache.
10. A non-transitory machine readable medium having stored thereon at least an instance of a single instruction, the instance of the single instruction to be processed by a machine to perform a method comprising: decoding the instance of a single instruction, the instance of the single instruction has at least one field for an opcode and at least one field to identify a location in memory that is to store a descriptor; and executing the decoded instruction according to the opcode to at least prefetch the descriptor, interpret fields of the descriptor, prefetch packed blocks representing matrix data from memory, decode and/or decompress the packed blocks, generate one or more index/value tokens or dense matrices based on sparsity metadata, and buffer the one or more index/value tokens or dense matrices based on sparsity metadata into a destination.
11. The method of example 10, wherein the one or more index/value tokens or dense matrices are buffered in a location accessible by matrix hardware.
12. The method of example 11, wherein the matrix hardware is one of a neural processing unit (NPU), a graphics processing unit (GPU), or a matrix processing unit (MPU).
13. The method of any of examples 10-12, wherein the descriptor is to include at least one of a base address of packed matrix blocks, an indication of a size of each packed matrix block, a data type, an indication of a sparse matrix format, an indication of the destination, an indication of a prefetch length, an indication of a transformation to perform, and/or an indication of a location for a codebook.
14. The method of example 13, wherein the packed matrix blocks are weights for a machine learning model.
15. The method of example 13, wherein the data type is at least one of a two-bit integer (INT2), a four-bit integer (INT4), an eight-bit integer (INT8), a sixteen-bit integer (INT16), a four-bit floating point (FP4), an 8-bit-bit floating point (FP8), or a sixteen-bit floating point (FP16).
16. The method of example 15, wherein the method further comprises generating dequantized index/value tokens or dense matrices based on sparsity metadata.
17. The method of any of examples 10-16, wherein the method further comprises decoding using a codebook.
18. The method of any of examples 10-17, wherein the memory is one of random dynamic access memory (DRAM), high-bandwidth memory (HBM), or cache.
19. A system comprising:
   matrix hardware;
   decoder circuitry to decode an instance of a single instruction, the instance of the single instruction has at least one field for an opcode and at least one field to identify a location in memory that is to store a descriptor; and
   execution circuitry to execute the decoded instruction according to the opcode to at least prefetch the descriptor, interpret fields of the descriptor, prefetch packed blocks representing matrix data from memory, decode and/or decompress the packed blocks, generate one or more index/value tokens or dense matrices based on sparsity metadata, and buffer the one or more index/value tokens or dense matrices based on sparsity metadata into a destination to be accessible by the matrix hardware.
20. The system of example 19, wherein the memory is one of random dynamic access memory (DRAM), high-bandwidth memory (HBM), or cache.
21. The system of example 19, wherein the matrix hardware is one of a neural processing unit (NPU), a graphics processing unit (GPU), or a matrix processing unit (MPU).

The specification and drawings are, accordingly, to be regarded in an illustrative rather than a restrictive sense. It will, however, be evident that various modifications and changes may be made thereunto without departing from the broader spirit and scope of the disclosure as set forth in the claims.

What is claimed is:

1. An apparatus comprising:
decoder circuitry to decode an instance of a single instruction, the instance of the single instruction has at least one field for an opcode and at least one field to identify a location in memory that is to store a descriptor; and
execution circuitry to execute the decoded instruction according to the opcode to at least prefetch the descriptor, interpret fields of the descriptor, prefetch packed blocks representing matrix data from memory, decode and/or decompress the packed blocks, generate one or more index/value tokens or dense matrices based on sparsity metadata, and buffer the one or more index/value tokens or dense matrices based on sparsity metadata into a destination.

2. The apparatus of claim 1, wherein the one or more index/value tokens or dense matrices are buffered in a location accessible by matrix hardware.

3. The apparatus of claim 2, wherein the matrix hardware is one of a neural processing unit (NPU), a graphics processing unit (GPU), or a matrix processing unit (MPU).

4. The apparatus of claim 1, wherein the descriptor is to include at least one of a base address of packed matrix blocks, an indication of a size of each packed matrix block, a data type, an indication of a sparse matrix format, an indication of the destination, an indication of a prefetch length, an indication of a transformation to perform, and/or an indication of a location for a codebook.

5. The apparatus of claim 4, wherein the packed matrix blocks are weights for a machine learning model.

6. The apparatus of claim 4, wherein the data type is at least one of a two-bit integer (INT2), a four-bit integer (INT4), an eight-bit integer (INT8), a sixteen-bit integer (INT16), a four-bit floating point (FP4), an 8-bit-bit floating point (FP8), or a sixteen-bit floating point (FP16).

7. The apparatus of claim 6, wherein the execution circuitry is to generate dequantized index/value tokens or dense matrices based on sparsity metadata.

8. The apparatus of claim 1, wherein the execution circuitry is to decode using a codebook.

9. The apparatus of claim 1, wherein the memory is one of random dynamic access memory (DRAM), high-bandwidth memory (HBM), or cache.

10. A non-transitory machine readable medium having stored thereon at least an instance of a single instruction, the instance of the single instruction to be processed by a machine to perform a method comprising:
decoding the instance of a single instruction, the instance of the single instruction has at least one field for an opcode and at least one field to identify a location in memory that is to store a descriptor; and
executing the decoded instruction according to the opcode to at least prefetch the descriptor, interpret fields of the descriptor, prefetch packed blocks representing matrix data from memory, decode and/or decompress the packed blocks, generate one or more index/value tokens or dense matrices based on sparsity metadata, and buffer the one or more index/value tokens or dense matrices based on sparsity metadata into a destination.

11. The method of claim 10, wherein the one or more index/value tokens or dense matrices are buffered in a location accessible by matrix hardware.

12. The method of claim 11, wherein the matrix hardware is one of a neural processing unit (NPU), a graphics processing unit (GPU), or a matrix processing unit (MPU).

13. The method of claim 10, wherein the descriptor is to include at least one of a base address of packed matrix blocks, an indication of a size of each packed matrix block, a data type, an indication of a sparse matrix format, an indication of the destination, an indication of a prefetch length, an indication of a transformation to perform, and/or an indication of a location for a codebook.

14. The method of claim 13, wherein the packed matrix blocks are weights for a machine learning model.

15. The method of claim 13, wherein the data type is at least one of a two-bit integer (INT2), a four-bit integer (INT4), an eight-bit integer (INT8), a sixteen-bit integer (INT16), a four-bit floating point (FP4), an 8-bit-bit floating point (FP8), or a sixteen-bit floating point (FP16).

16. The method of claim 15, wherein the method further comprises generating dequantized index/value tokens or dense matrices based on sparsity metadata.

17. The method of claim 10, wherein the method further comprises decoding using a codebook.

18. The method of claim 10, wherein the memory is one of random dynamic access memory (DRAM), high-bandwidth memory (HBM), or cache.

19. A system comprising:
matrix hardware;
decoder circuitry to decode an instance of a single instruction, the instance of the single instruction has at least one field for an opcode and at least one field to identify a location in memory that is to store a descriptor; and
execution circuitry to execute the decoded instruction according to the opcode to at least prefetch the descriptor, interpret fields of the descriptor, prefetch packed blocks representing matrix data from memory, decode and/or decompress the packed blocks, generate one or more index/value tokens or dense matrices based on sparsity metadata, and buffer the one or more index/value tokens or dense matrices based on sparsity metadata into a destination to be accessible by the matrix hardware.

20. The system of claim 19, wherein the memory is one of random dynamic access memory (DRAM), high-bandwidth memory (HBM), or cache.

21. The system of claim 19, wherein the matrix hardware is one of a neural processing unit (NPU), a graphics processing unit (GPU), or a matrix processing unit (MPU).
